(19) United States
(12) Patent Application Publication
(10) Pub. No.: US 2026/0356127 A1
(43) Pub. Date: Nov. 12, 2026

(54) TIRE

(71) Applicant: SUMITOMO RUBBER INDUSTRIES, LTD., Kobe-shi (JP)

(72) Inventor: Fumiya KATO, Kobe-shi (JP)

(73) Assignee: SUMITOMO RUBBER INDUSTRIES, LTD., Kobe-shi (JP)

(21) Appl. No.: 19/575,405

(22) Filed: Mar. 23, 2026

(30) Foreign Application Priority Data
Apr. 18, 2025 (JP) 2025-068905
Jan. 16, 2026 (JP) 2026-005644

(51) Int. Cl. B60C 1/00; C08K 3/04; C08K 3/06; C08K 3/22; C08K 3/36; C08K 5/00; C08K 5/09; C08K 5/5419; C08L 9/06

(52) U.S. Cl. CPC B60C 1/00; C08K 3/04; C08K 3/06; C08K 3/22; C08K 3/36; C08K 5/0025; C08K 5/09; C08K 5/5419; C08L 9/06; B60C 2001/0083; C08K 2003/2296; C08K 2201/005; C08L 2205/02

(57) ABSTRACT

A tire is further improved in an overall performance of wear resistance and chipping resistance. A tread portion includes a cap rubber layer, formed from a rubber composition containing styrene-butadiene rubber having a styrene content of less than 25% by mass, and containing more than 90 parts by mass of silica and more than 55 parts by mass of a resin component with respect to 100 parts by mass of the rubber component; and a complex modulus of elasticity 0 °C E* (MPa) measured at a temperature of 0 °C, a frequency of 10 Hz, an initial strain of 5%, a dynamic strain rate of 1%, and a deformation mode of elongation, a loss tangent tan δ measured at temperatures of 0 °C, −20 °C, −30 °C, and −40 °C under the conditions of a frequency of 10 Hz, an initial strain of 5%, a dynamic strain rate of 1%, and a deformation mode of tension, and a ratio C (%) of a thickness of the cap rubber layer to the thickness of the tread portion satisfy the following formulas (1) and (2).

B1[={(−40 °C tan δ)+(−30 °C tan δ)+(−20 °C tan δ)}×0 °C tan δ/0 °CE*]≥0.060 (1)

B1×C>1.0 (2)

### TECHNICAL FIELD

The present invention relates to a tire.

### BACKGROUND ART

In recent years, various proposals have been made to meet the demand for improvement of wear resistance, chipping resistance, and the like of tires to be mounted on vehicles (for example, Patent Documents 1 to 5), but further improvement of performances is desired.

### PRIOR ART DOCUMENTS

### Patent Documents

[Patent Document 1] JP 2019-218481 A
[Patent Document 2] JP 2020-59769 A
[Patent Document 3] JP 2021-25006 A
[Patent Document 4] JP 2022-121896 A
[Patent Document 5] JP 2024-2911 A

### SUMMARY OF THE INVENTION

### Problem to be Solved by the Invention

An object of the present invention is to further improve an overall performance of wear resistance and chipping resistance of a tire.

### Means for Solving the Problem

The present invention provides
a tire comprising a tread portion, wherein
the tread portion includes a cap rubber layer formed to a thickness (mm) having a ratio C (%) to a total thickness (mm) of the tread portion (mm),
the cap rubber layer is formed by using a rubber composition which contains styrene butadiene rubber (SBR) having a styrene content of less than 25% by mass in a rubber component, and further contains more than 90 parts by mass of silica, and more than 55 parts by mass of a resin component with respect to 100 parts by mass of the rubber component,
a complex modulus of elasticity 0 °C E* (MPa) of the cap rubber layer (measured under the conditions of a temperature of 0 °C, a frequency of 10 Hz, an initial strain of 5%, a dynamic strain rate of 1%, and a deformation mode of elongation), and loss tangents (0 °C tan δ, −20 °C tan δ, −30 °C tan δ, and −40 °C tan δ) of the cap rubber layer (measured under the conditions of a frequency of 10 Hz, an initial strain of 5%, a dynamic strain rate of 1%, a deformation mode of tension, and temperatures of 0 °C, −20 °C, −30 °C, and −40 °C respectively) satisfy the following formula (1), and
the following formula (2) is satisfied between B1 shown in the following formula (1), and the ratio C (%).

B1[={(−40 °C tan δ)+(−30 °C tan δ)+(−20 °C tan δ)}×0 °C tan δ/0 °CE*]≥0.060 (1)

B1×C>1.0 (2)

### Effects of the Invention

According to the present invention, it is possible to further improve the overall performance of wear resistance and chipping resistance.

### [1] Features of the Tire According to the Present Invention

First, the features of the tire according to the present invention are described.

### 1. Overview

The tire according to the present invention is a tire comprising a tread portion, wherein the tread portion includes a cap rubber layer formed to a thickness (mm) having a ratio C (%) to a total thickness (mm) of the tread portion (mm). The cap rubber layer is formed by using a rubber composition which contains styrene butadiene rubber (SBR) having a styrene content of less than 25% by mass in a rubber component, and further contains more than 90 parts by mass of silica, and more than 55 parts by mass of a resin component with respect to 100 parts by mass of the rubber component.

The cap rubber layer has a complex modulus of elasticity 0 °C E* (MPa), measured under the conditions of a temperature of 0 °C, a frequency of 10 Hz, an initial strain of 5%, a dynamic strain rate of 1%, and a deformation mode of elongation, and loss tangents (0 °C tan δ, −20 °C tan δ, −30 °C tan δ, and −40 °C tan δ), measured under the conditions of a frequency of 10 Hz, an initial strain of 5%, a dynamic strain rate of 1%, a deformation mode of tension, and temperatures of 0 °C, −20 °C, −30 °C, and −40 °C, satisfy the following formula (1), and the following formula (2) is satisfied between B1 shown in the following formula (1), and the ratio C (%).

B1[={(−40 °C tan δ)+(−30 °C tan δ)+(−20 °C tan δ)}×0 °C tan δ/0 °CE*]≥0.060 (1)

B1×C>1.0 (2)

By having these features, it is possible to further improve the overall performance of wear resistance and chipping resistance of the tire, as described later.

### 2. Mechanism of Exhibiting the Effect in a Tire According to the Present Invention

The mechanism, by which the above-described effects of the tire according to the present invention is exhibited, is considered to be as follows.

### (1) Containing a Low Styrene SBR

As described above, the cap rubber layer of the tread portion of the tire according to the present invention contains styrene butadiene rubber (SBR) having a styrene content of less than 25% by mass as a rubber component.

Since SBR (low styrene SBR), which has a low styrene content, specifically, a styrene content of less than 25% by mass, has a low glass transition temperature (Tg), it is possible to decrease Tg of a rubber component in the rubber composition forming the cap rubber layer by forming the cap rubber layer of the tread portion with compounding the low styrene SBR. Furthermore, since minute styrene domains are formed in the rubber matrix by the low styrene SBR, it is possible to enhance the mobility of polymer to make them move flexibly.

As a result, it is considered that cracks that lead to wear and chipping are less likely to occur, and overall performance of wear resistance and chipping resistance can be improved.

Furthermore, since the flexibly moving minute styrene domains generate heat easier by rubbing against each other, it is considered that chipping resistance can be improved by reducing input energy.

Furthermore, since minute styrene domains are formed to make interaction with the filler more likely to occur by compounding the low styrene SBR, it is considered that the reinforcing effect can be fully exhibited to enhance the fracture energy and wear resistance can be made to improve.

### (2) Containing Silica

In the present invention, the cap rubber composition contains a large amount, as more than 90 parts by mass, of silica, with respect to 100 parts by mass of the rubber component, as a reinforcing filler. It is considered that the overall performance of wear resistance and chipping resistance by the interaction between minute styrene domains that move flexibly and the silica, can be improved by containing such a large amount of silica.

### (3) Containing a Resin Component

In the present invention, the cap rubber composition contains a large amount, as more than 55 parts by mass, of a resin component with respect to 100 parts by mass of the rubber component in addition to silica. It is considered that since fracture energy is increased by containing such a large amount of the resin component, wear resistance can be improved.

### (4) Controlling B1

Loss tangent is an index that indicates performance to absorb energy, and it is considered that, since the larger the value, the more sufficiently the energy loss can be generated within the rubber composition, a chipping by deformation of rubber can be suppressed to occur so that chipping resistance can be improved.

On the other hand, complex modulus of elasticity is an index that indicates rigidity in a rubber composition, and it is considered that, since the smaller the value, the softer the rubber as a whole, slippage with a road surface is suppressed, and wear resistance can be increased.

Based on the above description, it is understood that in order to improve the overall performance of wear resistance and chipping resistance, necessary is appropriately controlling the balance between the loss tangent tan δ and the complex modulus of elasticity E*, that is, increasing the loss tangent tan δ of the rubber composition to some extent to improve chipping resistance, while decreasing the complex modulus of elasticity E* to some extent to improve wear resistance.

As a result of specific investigations, it is considered that the overall performance of wear resistance and chipping resistance can be improved by appropriately controlling B1, which is expressed by [{(−40 °C tan δ)+(−30 °C tan δ)+(−20 °C tan δ)}×0 °C tan δ}/0 °C E*], to be 0.060 or more.

In the present invention, the specific value of B1 is, for example, more preferably 0.061 or more, and even more preferably 0.065 or more. On the other hand, the upper limit is, for example, preferably 0.093 or less, and more preferably 0.071 or less.

When calculating the above-mentioned B1, the complex modulus of elasticity and the loss tangent can be measured using a viscoelasticity measuring device such as “EPLEXOR (registered trademark)” manufactured by GABO Corporation.

Specifically, a viscoelasticity measurement sample measuring 20 mm in length×4 mm in width×1 mm in thickness is collected by setting its long side along the circumferential direction of the tire from inside a cap rubber layer of the tread portion. Then, using the viscoelasticity measurement device, the loss tangents are measured under the conditions of a frequency of 10 Hz, an initial strain of 5%, a dynamic strain rate of 1%, and a deformation mode of tension, at a predetermined temperature. In addition, the complex modulus of elasticity E* is measured under the conditions of a frequency of 10 Hz, an initial strain of 5%, a dynamic strain rate of 1%, and a deformation mode of elongation, at a predetermined temperature. The thickness direction of the sample is set along the radial direction of the tire.

The loss tangent tan δ and the complex modulus of elasticity E* can be adjusted by types and amounts of chemicals, particularly, rubber components, fillers, resin components, sulfur, and vulcanization accelerators, compounded in the rubber composition (cap rubber layer, base rubber layer). For example, the loss tangent tan δ can be increased by increasing the content of SBR, or by increasing the content of a filler or a resin component. The complex modulus of elasticity E* can be increased by increasing the content of a filler, or by increasing the content of sulfur or a vulcanization accelerator.

### (5) Relationship Between Cap Ratio and B1

Furthermore, in the present invention, the product (B1×C) of the above-mentioned B1 and the cap ratio C is controlled to more than 1.0. It is considered that, by this, cracks, which lead to wear and chipping, become difficult to occur, and, thereby, overall performance of wear resistance and chipping resistance can be further improved. In other words, the overall performance of wear resistance and chipping resistance can be improved by appropriately controlling B1 to be large as described above. In addition, since heat accumulation during driving can be sufficiently suppressed by increasing the cap ratio and increasing the thickness of the cap rubber layer, it is considered that the overall performance of wear resistance and chipping resistance can be further improved.

In the present invention, specifically, B1×C is, for example, more preferably 1.43 or more, even more preferably 1.44 or more, even more preferably 1.46 or more. On the other hand, the upper limit is preferably 2.16 or less, more preferably 1.70 or less, and even more preferably 1.56 or less.

In the present invention, it is considered that each of the above-mentioned effects is exhibited in cooperation with each other, thereby making it possible to further improve the tire in the overall performance of wear resistance and chipping resistance.

### [2] More Preferred Embodiments of the Tire According to the Present Invention

The tire, according to the present invention, can achieve even greater effects by adopting the following embodiments.

### 1. Low Styrene SBR

As described above, by containing a low styrene SBR having a styrene content of less than 25% by mass or less, overall performance of wear resistance and chipping resistance can be improved. In this case, it is considered that, since, as the styrene content decreases, the glass transition temperature (Tg) also further decreases, clacks, which lead to wear and chipping become to difficult to occur so that the overall resistance of wear resistance and chipping resistance can be further improved.

In the present invention, the styrene content of the low styrene SBR is more preferably 22% by mass or less, even more preferably 20% by mass or less, even more preferably 15% by mass or less, and particularly preferably 10% by mass or less. On the other hand, the lower limit is preferably 3% by mass or more, more preferably 5% by mass or more, and even more preferably 7% by mass or more.

Here, a phrase such as “contains a low styrene SBR having a styrene content of less than 25% by mass” means that the amount of styrene in the entire SBR is less than 25% by mass.

In other words, when a single styrene-containing polymer (SBR) is contained in the rubber component, it is indicated that its styrene content is less than 25% by mass. And when a plurality of styrene-containing polymers (SBR) is contained in the rubber component, it is indicated that a styrene content calculated by sum of products of a styrene content (% by mass) in each polymer and a compounding amount (parts by mass) of each polymer with respect to 100 parts by mass of the rubber component is less than 25% by mass.

More specifically, when X1 parts by mass of SBR1 having a styrene content of S1% by mass and X2 parts by mass of SBR2 having a styrene content of S2% by mass are contained in 100 parts by mass of the rubber component, it is indicated that the styrene content calculated from the formula {(S1×X1)+(S2×X2)}/(X1+X2) is less than 25% by mass.

Furthermore, in a rubber composition after vulcanized, the styrene content in the rubber component can also be calculated by determining through solid-state nuclear magnetic resonance (solid-state NMR) or a Fourier transform infrared spectroscopy (FTIR).

The content of the low styrene SBR in 100 parts by mass of the rubber component is preferably more than 50 parts by mass, more preferably 60 parts by mass or more, even more preferably more than 60 parts by mass, even more preferably more than 65 parts by mass, and particularly preferably more than 70 parts by mass. The upper limit is, for example, preferably less than 90 parts by mass, more preferably less than 85 parts by mass, even more preferably less than 80 parts by mass, and even more preferably 74 parts by mass or less.

The glass transition temperature (Tg) of the low styrene SBR used in the present invention is preferably −25 °C or lower, more preferably −40 °C or lower, even more preferably −55 °C or lower, even more preferably −60 °C or lower, and particularly preferably −70 °C or lower. On the other hand, the lower limit is preferably −95 °C or higher, more preferably −90 °C or higher, even more preferably −85 °C or higher, and particularly preferably −80 °C or higher.

In the present invention, the glass transition temperature (Tg) of the cap rubber composition is preferably −15 °C or lower, more preferably −15.6 °C or lower, even more preferably −15.7 °C or lower, even more preferably −15.9 °C or lower, and even more preferably −16.5 °C or lower. On the other hand, the lower limit is preferably −25 °C or higher, more preferably −21.8 °C or higher, and even more preferably −19.6 °C or higher.

The above-described glass transition temperature (Tg) of SBR, and a cap rubber composition can be determined from a distribution curve of tan δ to temperature, measured using a viscoelasticity measuring device such as “EPLEXOR (a registered trademark)” series manufactured by GABO Corporation, and the like. Specifically, the distribution curve of tan δ to temperature is measured under conditions of a frequency of 10 Hz, an initial strain of 10%, an amplitude of ±0.5%, and a heating rate of 2 °C/min, and a temperature corresponding to the largest tan δ value in the range of −100 °C or higher, and 40 °C or lower on the distribution curve to temperature measured is taken as a glass transition temperature (Tg).

In addition, when there are two or more points with the largest tan δ value within the range of −100 °C or higher, and 40 °C or lower, the lowest temperature with the points is taken as a glass transition temperature (Tg). For example, in the present invention, when a tan δ peak is within the range of −100 °C or higher, and 40 °C or lower, the peak temperature is taken as the glass transition temperature (Tg) according to the above definition. Furthermore, for example, when a tan δ peak is in a region below −100 °C and a distribution curve of tan δ to temperature is obtained in which tan δ gradually decreases with increasing temperature within the range of −100 °C or higher, and 40 °C or lower, the glass transition temperature (Tg) is taken as −100 °C according to the above definition.

### 2. Silica

As described above, by containing a large amount of silica, i.e., more than 90 parts by mass with respect to 100 parts by mass of the rubber component, the overall performance of wear resistance and chipping resistance can be improved. The content of silica with respect to 100 parts by mass of the rubber component is more preferably more than 93 parts by mass, even more preferably more than 95 parts by mass, even more preferably more than 98 parts by mass, and particularly preferably 100 parts by mass or more. On the other hand, although the upper limit is not particularly limited, it is preferably less than 190 parts by mass, more preferably less than 180 parts by mass, even more preferably less than 170 parts by mass, even more preferably less than 160 parts by mass, and particularly preferably 135 parts by mass or less.

### 3. Resin Component

As described above, the overall performance of wear resistance and chipping resistance can be improved by containing a large amount of a resin component as more than 55 parts by mass with respect to 100 parts by mass of the rubber component. More than 60 parts by mass is more preferable, 65 parts by mass or more is even more preferable, and 68 parts by mass or more is particularly preferable. The upper limit is not particularly limited, but is preferably less than 85 parts by mass, more preferably less than 80 parts by mass, more preferably less than 75 parts by mass, and particularly preferably less than 70 parts by mass.

As the specific resin component, a rosin-based resin, a styrene-based resin, a coumarone-based resin, a terpene-based resin, a C5 resin, a C9 resin, a C5C9 resin, and an acrylic resin, and the like can be exemplified. Among these, the C5 resin and the C9 resin are more preferable, and a dicyclopentadiene resin (DCPD resin) and an AMS resin (α-methyl styrene resin) are particularly preferable. The dicyclopentadiene resin may be hydrogenated.

### 4. Relationship Between the Content of SBR and the Aspect Ratio

The aspect ratio is a ratio of the cross-sectional height to the tire cross-sectional width, and it is considered that the larger the ratio (higher aspect ratio), the smaller the contact area with the road surface, and the overall performance of wear resistance and chipping resistance can be improved. On the other hand, as described above, it is considered that the overall performance of wear resistance and chipping resistance can also be further improved by containing the low styrene SBR.

Therefore, it is considered that wear resistance and chipping resistance can be further improved by increasing the product (C_{S}×A) of the content of SBR Cₛ (parts by mass) in 100 parts by mass of the rubber component and the aspect ratio A (%) of the tire.

Specifically, C_{S}×A is preferably more than 2000, more preferably more than 2500, even more preferably 2700 or more, even more preferably more than 3000, even more preferably 3330 or more, and particularly preferably more than 3500. The upper limit is not particularly limited, but is, for example, preferably less than 6500, more preferably less than 6000, and even more preferably less than 5500.

### 5. Relationship Between Silica Content and Negative Rate

The negative rate refers to a ratio (%) of the total opening area of multiple grooves to a virtual contact area of the tread portion with all multiple grooves filled (i.e., a total contact area around the entire circumference of a tire that comes into contact with a ground when the tire comprising the tread portion with all multiple grooves filled is made to be a standardized state, and the tread portion is pressed against a flat surface at a camber angle of 0° under conditions of a standardized internal pressure and a standardized load). It is considered that since the ratio is smaller (the negative rate is lower), the contact area with a ground becomes larger so that a great energy loss can be generated across the entire tread surface, the overall performance of wear resistance and chipping resistance can be improved.

On the other hand, it is considered that also if silica, which is a reinforcing filler, is contained in a large amount, the overall performance of wear resistance and chipping resistance can be improved as described above.

Because of this, it is considered that the overall performance of wear resistance and chipping resistance can be improved by appropriately controlling a ratio (C_{SI}/N) of a content C_{SI} of silica with respect to 100 parts by mass of the rubber component to a negative rate N (%) of the tire. Specifically, the ratio (C_{SI}/N) is preferably more than 3, more preferably 3.03 or more, and even more preferably more than 3.1. The upper limit is not particularly limited, but is, for example, preferably less than 4.5, more preferably 4.09 or less, and even more preferably less than 4.

In the present invention, the specific negative rate is, for example, preferably 45% or less, more preferably 40% or less, and even more preferably 33% or less. On the other hand, the lower limit is preferably 20% or more, more preferably 25% or more, and even more preferably 30% or more.

The above-mentioned negative rate can be determined from a ground contact area under conditions of a standardized rim, a standardized internal pressure, and a standardized load.

Specifically, the ground contact area is obtained by, after being mounted on a standardized rim, applied with a standardized internal pressure, and left under a temperature of 25 °C for 24 hours, applying ink on the surface of the tire and pressing (camber angle 0°) against a cardboard under a standardized load to transfer onto the cardboard. Transferring from five locations is done while the tire is rotated of 72° in the circumferential direction at a time. In other words, the ground contact area is obtained five times. For the five ground contact areas, an average value of the maximum length in the axial direction of the tire is defined as L, and an average value of the maximum length in the direction perpendicular to the axial direction is defined as W. The negative rate (%) is calculated as [1−{average area of the five ground contact areas (inked portions) transferred to cardboard/(L×W)}]×100(%). Here, the average values of the length and the area are simple averages of the five values. And L×W in the formula refers to an area of an imaginary surface obtained by joining blank areas created by main grooves and lateral grooves when the ground contact areas are obtained.

Here, the “standardized condition” refers to a state in which the tire is mounted on a standardized rim, and inflated to a standardized internal pressure, and, further, under no load.

Note that the “standardized rim” refers to a rim that is determined for each tire by a standard system that includes a standard on which the tire is based. For example, in the case of JATMA (Japan Automobile Tire Manufacturers Association), a standardized rim for an applicable size listed in “JATMA YEAR BOOK” is referred to. In the case of ETRTO (The European Tyre and Rim Technical Organization), “Measuring Rim” listed in “STANDARDS MANUAL” is referred to. In the case of TRA (The Tire and Rim Association, Inc.), “Design Rim” listed in “YEAR BOOK” is referred to. JATMA, ETRTO, and TRA are referenced in that order, and if an applicable size is available at the time of reference, the standard is followed. In the case of tires not specified by any standards, a rim having the smallest rim diameter and, secondly, having the narrowest rim width among rims that do not cause air leakage between the rim and the tire, i.e., rims those can be mounted on, and can maintain the internal pressure, is referred to.

The “standardized internal pressure” refers to air pressure determined for each tire by a standard system that includes a standard on which the tire is based. In the case of JATMA, the maximum air pressure is referred to. In the case of ETRTO, “INFLATION PRESSURE” is referred to. In the case of TRA, the maximum value listed in the table of “TIRE LOAD LIMITS AT VARIOUS COLD INFLATION PRESSURE” is referred to. JATMA, ETRTO, and TRA are referenced in that order, and if an applicable size is available at the time of reference, the standard is followed. In the case of tires not specified by any standards, a standardized internal pressure (250 kPa or more) for another tire size (specified in a standard), for which the above standardized rim is specified as its standardized rim, is referred to. Note that if multiple standardized internal pressures of 250 KPa or more are specified, the smallest value among them is referred to.

Furthermore, the “standardized load” refers to a load specified for each tire by each standard in the standard system including a standard on which the tire is based and refers to the maximum mass that can be loaded on the tire. In the case of JATMA, the maximum load capacity is referred to. In the case of ETRTO, “LOAD CAPACITY” is referred to. In the case of TRA, the maximum value listed in the table of “TIRE LOAD LIMITS AT VARIOUS COLD INFLATION PRESSURES” is referred to. As with the above-mentioned “standardized rim” and “standardized internal pressure”, JATMA, ETRTO, and TRA are referenced in that order and the standards are followed. In the case of a tire not specified in any standards, the standardized load W_{L} is found by the following calculation:

V={(Dt/2)²−(Dt/2−Ht)²}×π×Wt

W_{L}=0.000011×V+175
W_{L}: Standardized load (kg)
V: Virtual volume of the tire (mm³)
Dt: Tire outer diameter Dt (mm)
Ht: Tire cross-sectional height (mm)
Wt: Tire cross-sectional width (mm)

### 6. Relationship Between the Content of Resin and the Negative Rate

Similarly to the above, it is considered that the overall performance of wear resistance and chipping resistance can be improved by appropriately controlling the ratio (C_{R}/N) of a content of the resin component C_{R} (parts by mass) with respect to 100 parts by mass of the rubber component of the resin component to the negative rate N (%) on the surface of the tread portion of the tire. Specifically, the ratio (C_{R}/N) is preferably more than 2.0, more preferably 2.06 or more, even more preferably more than 2.1, and even more preferably more than 2.2. The upper limit is not particularly limited, but is, for example, preferably less than 3.5, and more preferably less than 3.0.

### 7. Cap Ratio

The tread portion includes a cap rubber layer. The cap rubber layer may be the outermost layer, with a base rubber layer provided inside the cap rubber layer, forming a two-layer structure, or alternatively, three layers, or four or more layers. In this case, the ratio (cap ratio) of a thickness of the cap rubber layer to a thickness of the tread portion is preferably more than 10%, more preferably 15% or more, even more preferably 20% or more, even more preferably 24% or more, and particularly preferably 25% or more. It is considered that the overall performance of wear resistance and chipping resistance can be further improved by this. The upper limit is not particularly limited, but is preferably 90% or less, more preferably 80% or less, and even more preferably 70% or less.

The thickness of the tread portion is preferably 5 mm or more, more preferably 6 mm or more, even more preferably 8 mm or more, and even more preferably 12.5 mm or more. It is considered that the overall performance of wear resistance and chipping resistance can be further improved by this. The upper limit is not particularly limited, but for example, it is preferably 20 mm or less, more preferably 18 mm or less, and even more preferably 16 mm or less.

The cap rubber layer is not limited to the cap rubber layer that forms the outermost layer of the tread portion, and if there are two or more layers within 5 mm from the surface of the tread toward the inside, at least any one of the layers may satisfy the above-described requirements of the rubber composition.

Here, the thickness of the tread portion refers to the thickness of the tread portion on the tire equatorial plane in a cross section in a radial direction of the tire. When the tread portion is formed of a single rubber composition, it refers to the thickness of the rubber composition. When the tread portion is formed of a laminated structure of multiple rubber compositions, it refers to the total thickness of these layers.

For example, in the case where a groove is present on the tire equatorial plane, it refers to the thickness from the intersection of a line connecting the radially outermost end points of the groove and the tire equatorial plane to the radially innermost interface of the tread portion.

The thickness of the tread portion can be calculated by adding up the thickness of the cap rubber layer (total of all if there are two or more layers) and the thickness of the base rubber layer (total of all if there are two or more layers) in the tread portion. Here, “thickness of the cap rubber layer” refers to the thickness of the cap rubber layer on the tire equatorial plane in a cross section of the tire radial direction. In the case where a groove is present on the tire equatorial plane, it refers to the thickness from the intersection of a line connecting the radially outermost end points of the groove, and the tire equatorial plane to the interface to the base rubber layer at the radially innermost portion of the tire in the tread portion. The “thickness of base rubber layer” refers to the thickness to the interface of the radially innermost portion in the tire of the tread portion from the interface with the cap rubber layer. Note that the “groove” refers to one having an opening width of 3 mm or more at the outermost surface of the tread portion and a depth of 3 mm or more.

The tread portion is a component that forms the ground contact surface of the tire, and refers to the portion radially outward of components that contain fiber materials, and the like, such as a carcass, a belt layer, and a belt reinforcing layer. The above-mentioned thickness of the tread portion can be measured by adapting the bead portion to a standardized rim width on a cross section of the tire cut out in the radial direction.

### 8. Particle Size of Silica

Considering the ease of friction with polymers, and the like, the particle size (average primary particle size) of silica is preferably 16 nm or less, more preferably 15 nm or less. By using silica having a small particle size, it is considered that the frequency of contact with the polymer (styrene domain) of styrene butadiene rubber (SBR) can be increased, and thereby the overall performance of wear resistance and chipping resistance is further improved. For example, the lower limit is not particularly limited, but is preferably more than 8 nm, and more preferably more than 10 nm.

The average primary particle size can be calculated by directly observing silica particles extracted from a rubber composition cut out from a tire by using a transmission electron microscope (TEM) and the like, calculating the equivalent cross-sectional area diameter from the area of each silica particle obtained, and determining the average value.

### 9. Isoprene-Based Rubber

Containing an isoprene-based rubber in the rubber component is preferable. Since microscopic layers of different hardness are mixed in the rubber phase by containing an isoprene-based rubber in addition to the low-styrene SBR, wear resistance can be improved, and chipping resistance can also be improved.

The content of the isoprene-based rubber in 100 parts by mass of the rubber component is preferably more than 3 parts by mass, more preferably more than 5 parts by mass, even more preferably 10 parts by mass or more, even more preferably more than 10 parts by mass, and even more preferably 16 parts by mass or more. On the other hand, the upper limit is preferably less than 40 parts by mass, more preferably less than 35 parts by mass, even more preferably 30 parts by mass or less, even more preferably less than 30 parts by mass, and particularly preferably less than 25 parts by mass.

As the isoprene-based rubber, natural rubber (NR), a reformed natural rubber (reformed NR), a modified natural rubber (modified NR), a synthetic polyisoprene (isoprene rubber (IR)), a modified isoprene rubber (modified IR), and the like can be exemplified. Among them, NR having excellent strength is preferable. As specific NR, those common in the tire industry, for example, SVR-L, SIR20, RSS #3, TSR20, and the like, can be used.

### [3] Embodiment

The present invention is specifically described below based on embodiments.

### 1. Rubber Composition

In the tire according to the present invention, the rubber composition (rubber composition for tread) forming the tread portion (comprising a cap rubber layer) can be obtained by appropriately adjusting types and amounts of various compounding materials described below, for example, a rubber component, a filler, a softener, a vulcanizing agent, a vulcanization accelerator, and the like.

### (1) Compounding Materials

### (a) Rubber Component

As described above, a low styrene SBR is used as a rubber component. As rubber components other than the low styrene SBR that is used, rubbers (polymers) commonly used in the tire production, such as an isoprene-based rubber, a diene-based rubber such as butadiene rubber (BR), or a nitrile rubber (NBR), a butyl-based rubber such as butyl rubber, and thermoplastic elastomers such as a styrene-butadiene-styrene block copolymer (SBS), and a styrene-butadiene block copolymer (SB) are exemplified.

(a-1) SBR

The weight-average molecular weight of SBR is, for example, preferably more than 100,000, more preferably 200,000 or more, even more preferably 300,000 or more, and even more preferably 400,000 or more. On the other hand, the upper limit is preferably less than 2,000,000, more preferably less than 1,000,000, even more preferably less than 800,000, and even more preferably 600,000 or less.

As described above, in the present invention, the styrene content in the SBR component is less than 25% by mass or less. The vinyl content (content of 1,2-bonded butadiene) of SBR is, for example, preferably more than 5% by mass, more preferably 20% by mass or more, while the upper limit is, preferably less than 70% by mass, more preferably 59 parts by mass or les. The vinyl content of SBR refers to a content of 1,2-bonded butadiene with respect to the total butadiene moieties in the SBR component. Furthermore, the structure identification of SBR (measurement of the styrene content and the vinyl content) can be conducted by using JNM-ECA series instrument manufactured by JEOL Ltd. Different from a value of a physical property such as the complex modulus of elasticity (E*), the amount of a component such as “styrene content” has a true value that is independent of the measurement method, and, therefore, using a measurement method with as high accuracy as possible is preferable.

As SBR, not particularly limited, for example, an emulsion polymerized styrene butadiene rubber (E-SBR), a solution polymerized styrene butadiene rubber (S-SBR), and the like can be used. SBR may be either a non-modified SBR or a modified SBR. Further, a hydrogenated SBR obtained by hydrogenating a butadiene part in SBR may be used. The hydrogenated SBR may be obtained by hydrogenating a BR part in SBR subsequently, or a similar structure may be obtained by copolymerizing styrene, ethylene, and butadiene. The content of SBR in 100 parts by mass of the rubber component is as described above.

The modified SBR may be SBR having a functional group that interacts with a filler such as silica. Examples thereof include an end-modified SBR (end-modified SBR having the above functional group at the end) in which at least one end of the SBR is modified with a compound (modifying agent) having the above functional group, a main chain modified SBR having the functional group in the main chain, a main chain end modified SBR having the functional group at the main chain and the end (for example, a main chain end modified SBR having the above functional group to the main chain and having at least one end modified with the above modifying agent), and an end-modified SBR which is modified (coupled) with a polyfunctional compound having two or more epoxy groups in the molecule to be introduced with a hydroxyl group or an epoxy group.

Examples of the functional group include an amino group, an amide group, a silyl group, an alkoxy silyl group, an isocyanate group, an imino group, an imidazole group, a urea group, an ether group, a carbonyl group, an oxycarbonyl group, a mercapto group, a sulfide group, a disulfide group, a sulfonyl group, a sulfinyl group, a thiocarbonyl group, an ammonium group, an imide group, a hydrazo group, an azo group, a diazo group, a carboxyl group, a nitrile group, a pyridyl group, an alkoxy group, a hydroxyl group, an oxy group, an epoxy group, and the like. In addition, these functional groups may have a substituent.

Furthermore, as the modified SBR, for example, SBR modified with a compound (modifying agent) represented by the following formula can be used.

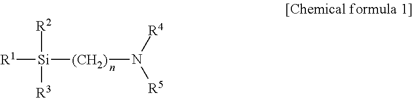

In the formula, R¹, R² and R³ are the same or different, and each represents an alkyl group, an alkoxy group, a silyloxy group, an acetal group, a carboxyl group (—COOH), a mercapto group (—SH), or a derivative thereof. R⁴ and R⁵ are the same or different, and each represents a hydrogen atom, or an alkyl group. R⁴ and R⁵ may be combined to form a ring structure together with a nitrogen atom. Indicated by n is an integer.

As the modified SBR modified with the compound (modifying agent) represented by the above formula, SBR in which the polymerization end (active end) of the solution-polymerized styrene butadiene rubber (S-SBR) is modified with the compound represented by the above formula (for example, modified SBR described in JP 2010-111753 A, and the like), can be used.

As R¹, R² and R³, alkoxy groups are preferable (alkoxy groups preferably having 1 to 8 carbon atoms, more preferably 1 to 4 carbon atoms). As R⁴ and R⁵, alkyl groups are preferable (preferably alkyl groups having 1 to 3 carbon atoms). Preferably, n is 1 to 5, more preferably 2 to 4, and further preferably 3. When R⁴ and R⁵ bond to form a ring structure together with a nitrogen atom, it is preferred to form a 4- to 8-membered ring. Incidentally, the alkoxy groups also include cycloalkoxy groups (cyclohexyloxy groups, and the like) and aryloxy groups (phenoxy groups, benzyloxy groups, and the like).

Specific examples of the above modifying agent include 2-dimethylamino ethyl trimethoxy silane, 3-dimethylaminopropyltrimethoxysilane, 2-dimethyl aminoethyl triethoxysilane, 3-dimethylaminopropyltriethoxysilane, 2-diethylamino ethyl trimethoxy silane, 3-diethylaminopropyltrimethoxysilane, 2-diethylaminoethyltriethoxysilane, 3-diethylaminopropyltriethoxysilane, and the like. These may be used alone or in combination of two or more.

Further, as the modified SBR, a modified SBR modified with the following compound (modifying agent) can also be used. Examples of the modifying agent include polyglycidyl ethers of polyhydric alcohols such as ethylene glycol diglycidyl ether, glycerin triglycidyl ether, trimethylolethane triglycidyl ether, and trimethylolpropane triglycidyl ether; polyglycidyl ethers of aromatic compounds having two or more phenol groups such as diglycidylated bisphenol A; polyepoxy compounds such as 1,4-diglycidyl benzene, 1,3,5-triglycidylbenzene, and polyepoxidized liquid polybutadiene; epoxy group-containing tertiary amines such as 4,4′-diglycidyl-diphenyl methyl amine, and 4,4′-diglycidyl-dibenzylmethylamine; diglycidylamino compounds such as diglycidylaniline, N, N′-diglycidyl-4-glycidyloxyaniline, diglycidyl orthotoluidine, tetraglycidyl meta xylene diamine, tetraglycidyl amino diphenylmethane, tetraglycidyl-p-phenylenediamine, diglycidylamino methyl cyclohexane, and tetraglycidyl-1,3-bisaminomethylcyclohexane; amino group-containing acid chlorides such as bis-(1-methylpropyl) carbamate chloride, 4-morpholincarbonyl chloride, 1-pyrrolidincarbonyl chloride, N,N-dimethyl carbamide acid chloride, and N,N-diethyl carbamide acid chloride; epoxy group-containing silane compounds such as 1,3-bis-(glycidyloxypropyl)-tetramethyldisiloxane, and (3-glycidyloxypropyl)-pentamethyldisiloxane; sulfide group-containing silane compound such as (trimethylsilyl)[3-(trimethoxysilyl)propyl]sulfide, (trimethylsilyl)[3-(triethoxysilyl)propyl]sulfide, (trimethylsilyl)[3-(tripropoxysilyl)propyl]sulfide, (trimethylsilyl)[3-(tributoxysilyl)propyl]sulfide, (trimethylsilyl)[3-(methyldimethoxysilyl)propyl]sulfide, (trimethylsilyl)[3-(methyldiethoxysilyl)propyl]sulfide, (trimethylsilyl) [3-(methyldipropoxysilyl)propyl]sulfide, and (trimethylsilyl)[3-(methyldibutoxysilyl)propyl]sulfide; N-substituted aziridine compound such as ethyleneimine and propylene imine; alkoxysilanes such as methyl triethoxy silane, N,N-bis(trimethylsilyl)-3-aminopropyltrimethoxysilane, N,N-bis (trimethylsilyl)-3-aminopropyltriethoxysilane, N,N-bis(trimethylsilyl)amino ethyl trimethoxy silane, and N,N-bis(trimethylsilyl)aminoethyltriethoxysilane; (thio)benzophenone compound having an amino group and/or a substituted amino group such as 4-N,N-dimethylaminobenzophenone, 4-N,N-di-t-butyl amino benzophenone, 4-N,N-diphenyl amino benzophenone, 4,4′-bis(dimethyl amino)benzophenone, 4,4′-bis(diethylamino)benzophenone, 4,4′-bis(diphenyl amino)benzophenone, and N,N,N′,N′-bis-(tetraethyl amino)benzophenone; benzaldehyde compounds having an amino group and/or a substituted amino group such as 4-N,N-dimethylaminobenzaldehyde, 4-N,N-diphenylamino benzaldehyde, and 4-N,N-divinyl amino benzaldehyde; N-substituted pyrrolidone such as N-methyl-2-pyrrolidone, N-vinyl-2-pyrrolidone, N-phenyl-2-pyrrolidone, N-t-butyl-2-pyrrolidone, and N-methyl-5-methyl-2-pyrrolidone; N-substituted piperidone such as N-methyl-2-piperidone, N-vinyl-2-piperidone, and N-phenyl-2-piperidone; N-substituted lactams such as N-methyl-ε-caprolactam, N-phenyl-ε-caprolactam, N-methyl-ω-laurylolactam, N-vinyl-ω-laurylolactam, N-methyl-ß-propiolactam, and N-phenyl-ß-propiolactam; and N,N-bis-(2,3-epoxypropoxy)-aniline, 4,4-methylene-bis-(N,N-glycidyl aniline), tris-(2,3-epoxypropyl)-1,3,5-triazine-2,4,6-triones, N,N-diethyl acetamide, N-methylmaleimide, N,N-diethyl urea, 1,3-dimethylethylene urea, 1,3-divinyl ethylene urea, 1,3-diethyl-2-imidazolidinone, 1-methyl-3-ethyl-2-imidazolidinone, 4-N,N-dimethyl aminoacetophenone, 4-N,N-diethylamino acetophenone, 1,3-bis(diphenylamino)-2-propanone, and 1,7-bis (methylethylamino)-4-heptanone. The modification with the above compound (modifying agent) can be conducted by a known method.

As SBR, SBR manufactured and sold by Sumitomo Chemical Co., Ltd., ENEOS Materials Corporation, Asahi Kasei Corporation, Zeon Corporation, and the like can be used. SBR may be used alone or in combination of two or more types.

(a-2) Isoprene-Based Rubber

As the isoprene-based rubber, as described above, natural rubber (NR), a reformed natural rubber (reformed NR), a modified natural rubber (modified NR), a synthetic polyisoprene (isoprene rubber (IR)), a modified isoprene rubber (modified IR), and the like can be exemplified. The content of the isoprene-based rubber in 100 parts by mass of the rubber component is as described above.

As NR, those common in the tire industry, for example, SIR20, RSS #3, TSR20, and the like, can be used. As IR, not particularly limited, those common in the tire industry, for example, IR2200, and the like, can be used. As the reformed NR, a deproteinized natural rubber (DPNR), a high-purity natural rubber (UPNR), and the like; as the modified NR, an epoxidized natural rubber (ENR), an hydrogenated natural rubber (HNR), a grafted natural rubber, and the like; and as the modified IR, an epoxidized isoprene rubber, a hydrogenated isoprene rubber, a grafted isoprene rubber, and the like, are exemplified. These may be used alone or in combination of two or more.

(a-3) BR

In the present invention, if necessary, BR may be contained further. In this case, the content of BR in 100 parts by mass of the rubber component is preferably 5 parts by mass or more, more preferably 7 parts by mass or more, even more preferably 10 parts by mass or more. On the other hand, 20 parts by mass or less is preferable, 17 parts by mass or less is more preferable, and 16 parts by mass or less is even more preferable.

The weight average molecular weight of BR is, for example, more than 100,000, and less than 2,000,000. The vinyl content of BR is, for example, more than 1% by mass, and less than 30% by mass. The cis content of BR is, for example, more than 1% by mass, and less than 98% by mass. The trans content of BR is, for example, more than 1% by mass, and less than 60% by mass.

As BR, not particularly limited, BR having a high cis content (cis content of 90% or more), BR having a low cis content, BR containing syndiotactic polybutadiene crystals, and the like can be used. BR may be either of an unmodified BR or a modified BR. As the modified BR, a modified BR, in which the aforementioned functional group is introduced, is exemplified. These may be used alone or in combination of two or more. The cis content can be measured by infrared absorption spectroscopy.

As BR, for example, products of UBE Corporation, ENEOS Materials Corporation, Asahi Kasei Corporation, Zeon Corporation, and the like can be used.

(a-4) Other Rubber Components

Furthermore, as other rubber components, rubbers (polymers) that are generally used for producing tires, such as nitrile rubber (NBR), may be contained, as necessary.

A raw material (monomer) of the above-described synthetic rubber such as SBR or BR may be one derived from petroleum or may be one recycled from a rubber product such as a tire, or a non-rubber product such as polystyrene.

As the monomer obtained by recycling (recycled monomer), not particularly limited, a recycled butadiene, and a recycled aromatic vinyl, and the like are exemplified. As the above-mentioned butadiene, 1,2-butadiene, and 1,3-butadiene are exemplified. As the above-mentioned aromatic vinyl, not particularly limited, styrene, and the like are exemplified. Among these, using a butadiene obtained by recycling (recycled butadiene) and/or a styrene obtained by recycling (recycled styrene) as the raw material is preferable.

As a method for producing the recycled monomer is not particularly limited, and, for example, synthesis from a recycled naphtha obtained by decomposing a rubber product such as a tire is exemplified. Also, a method for producing the recycled naphtha is not particularly limited, and, for example, a rubber product such as a tire may be decomposed under a high temperature, and a high pressure, may be decomposed with microwaves, or may be crushed mechanically, and extracted thereafter.

Furthermore, the raw material (monomer) of the synthetic rubber, such as SBR, BR, or the like, may be one derived from biomass. As a biomass-derived monomer (biomass monomer), not particularly limited, a biomass-derived butadiene, a biomass-derived aromatic vinyl, and the like are exemplified. As the above-mentioned butadiene, 1,2-butadiene, and 1,3-butadiene are exemplified. As the above-mentioned aromatic vinyl, not limited to, styrene, and the like are exemplified. Furthermore, a method for producing the biomass monomer is not particularly limited, and, for example, one by a biological and/or chemical and/or physical conversion of animals and plants is exemplified. As the biological conversion, fermentation by microorganisms is typical. As the chemical and/or physical conversion, one by catalytic, one by high-temperature, one by high-pressure, one by electromagnetic, one by critical fluid, and combinations thereof are exemplified. As biomass source for these monomers, sugar, wood, a plant residue after extracting useful components, a plant-derived ethanol, a biomass naphtha, and the like are exemplified.

As a polymer synthesized from a biomass monomer component (biomass polymer), not particularly limited, exemplified are a polybutadiene rubber synthesized from a biomass-derived butadiene, and an aromatic vinyl/butadiene copolymer synthesized from the biomass-derived butadiene and/or a biomass-derived aromatic vinyl. As the aromatic vinyl/butadiene copolymer, for example, exemplified are a styrene butadiene rubber synthesized from the biomass-derived butadiene and/or the biomass-derived styrene, and the like.

Whether a raw material of a polymer is derived from a biomass or not can be determined by pMC (percent modern carbon) measured in accordance with ASTM D6866-10.

The pMC is a ratio of ¹⁴C concentration of a sample with respect to ¹⁴C concentration of the modern standard reference of carbon, and this value is used as an index of the biomass ratio of a compound (rubber). The significance of this value is described below.

In one mole (6.02×10²³) of carbon atoms, there are approximately 6.02×10¹¹ of ¹⁴C, which are approximately one trillionth of the number of normal carbon atoms. ¹⁴C is called a radioactive isotope, has a half-life of 5,730 years, and decays regularly. It takes 226,000 years for all of them to decay. Therefore, in fossil fuels such as coal, oil, and natural gas, which are considered to have passed 226,000 years or more after carbon dioxide in the atmosphere was absorbed and fixed to plants and the like, all of the ¹⁴C elements that were contained in them at the time of fixation have decayed. Therefore, in the present 21st century, fossil fuels such as coal, oil, and natural gas do not contain any ¹⁴C elements at all. Therefore, chemical substances produced using these fossil fuels as raw materials do not contain any ¹⁴C elements at all.

On the other hand, ¹⁴C is constantly produced as a result of nuclear reactions caused by cosmic rays in the atmosphere, and the amount of ¹⁴C in the atmospheric environment on Earth is constant due to a balance with decrease caused by radioactive decay. Therefore, ¹⁴C concentration of substances derived from biomass resources material-circulating in the current environment is approximately 1×10⁻¹² mol % with respect to the total C atoms, as mentioned above. Therefore, the difference between these values can be used to calculate the ratio (biomass ratio) of compounds derived from natural resources (compounds derived from biomass resources) in a certain compound (rubber).

This ¹⁴C is generally measured as follows. An accelerator mass spectrometry based on a tandem accelerator is used to measure the ¹³C concentration (¹³C/¹²C) and the ¹⁴C concentration (¹⁴C/¹²C). In the measurement, the ¹⁴C concentration in circulating carbon in nature as of 1950 is used as the modern standard reference to be standard for the ¹⁴C concentration. As a specific standard substance, used is an oxalic acid standard provided by NIST (National Institute of Standards and Technology). The specific radioactivity of a carbon in this oxalic acid (radioactivity intensity of ¹⁴C with respect to one gram of carbon) is separated for each carbon isotope. It is corrected to be a constant value regarding ¹³C, and the value corrected for decay from 1950 to the date of measurement is used as the standard of ¹⁴C concentration value (100%). The ratio between this value and the value of the actual measured sample is the pMC value.

Therefore, if a rubber is made from 100% biomass (natural) derived materials, a value of approximately 110 pMC is to be shown, although there may be regional differences and the like (currently, under normal conditions, it is often not to be 100). On the other hand, when the ¹⁴C concentration of chemical substances derived from fossil fuels such as petroleum is measured, approximately 0 pMC (for example, 0.3 pMC) is to be shown. This value corresponds to the biomass ratio of 0% described above.

From the above, using a material, such as rubber, having a high pMC value, that is, a material, such as rubber having a high biomass ratio, for a rubber composition is preferable in a view of contributing to environmental protection, and improving sustainability.

(b) Compounding Materials Other than Rubber Components
(b-1) Filler

As described above, the rubber composition contains silica as a reinforcing filler, but other fillers, such as carbon black, graphite, calcium carbonate, talc, alumina, clay, aluminum hydroxide, and mica, may also be contained.

(i-1) Silica

A BET specific surface area of silica is preferably more than 140 m²/g, more preferably more than 160 m²/g, from the viewpoint of obtaining good abrasion resistance and chipping resistance. On the other hand, from the viewpoint of dispersibility in the rubber composition, it is preferably less than 300 m²/g, more preferably less than 250 m²/g, and even more preferably less than 220 m²/g. The above-mentioned BET specific surface area is a value of N₂ S A measured by BET method in accordance with ASTM D3037-93.

In this case, the particle size (average primary particle size) of silica is preferably 16 nm or less, as described above.

As silica, for example, silica made by a dry-process (anhydrous silica), silica made by a wet-process (hydrated silica), and the like can be exemplified. Among them, silica made by the wet-process is preferred because of having a large number of silanol groups. Silica made by using hydrous glass and the like as a raw material, or silica made by using a biomass material of rice husks, and the like as raw material, and the like may also be used.

As silica, for example, products from Evonik Industries AG, Rhodia, Tosoh Silica Corporation, Solvay Japan Co., Ltd., Tokuyama Corporation, and the like can be used.

As a raw material for silica, not particularly limited, for example, a mineral-derived raw material such as quartz, a biological raw material such as a rice husk (for example, silica by using a biomass material of a rice husk, and the like as raw material), or silica recycled from a product containing silica may be used. Among them, a hydrated silica made by a wet process is preferred because of having a large amount of silanol groups.

Silica by using a biomass material as a raw material can be obtained, for example, by extracting silicate from rice husk ashes obtained by burning rice husks using a sodium hydroxide solution, and then reacting the silicate with sulfuric acid, in the same manner as conventional silica made by a wet-process, to produce a silicon dioxide precipitate, which is then filtered, washed with water, dried, and pulverized.

For silica recycled from a product containing silica, for example, silica recovered from a product containing silica, such as electronic components, e.g., semiconductors, and the like, tires, desiccants, filtering materials, e.g., diatomaceous earth, and the like, can be used. As a method for recovering silica, not particularly limited, thermal decomposition, decomposition by electromagnetic waves, and the like are exemplified. Among them, silica recovered from electronic components such as semiconductors, or tires is preferable.

When silica crystallizes, it becomes insoluble in water, and its component, silicic acid, cannot be utilized. The crystallization of silica in rice husk ashes can be suppressed by controlling combustion temperature and duration (see, for example, JP 2009-2594 A, and Akita Prefectural University Web Journal B/2019, vol. 6, p. 216-222).

As amorphous silica extracted from rice husks, one commercially available from Wilmar International Limited, and the like can be used.

These of silica may be used alone or in combination of two or more. Using a biomass silica or a recycled silica is preferred from the viewpoint of contributing to environmental protection and improving sustainability.

(i-2) Silane Coupling Agent

When using the above-mentioned silica, a silane coupling agent is preferably contained together with silica.

As the silane coupling agents, not particularly limited, for example, sulfide-based agents, such as bis(3-triethoxysilyl propyl)tetra sulfide, bis(2-triethoxysilylethyl)tetra sulfide, bis(4-triethoxysilyl butyl)tetra sulfide, bis(3-trimethoxysilylpropyl)tetra sulfide, bis(2-trimethoxysilyl ethyl)tetra sulfide, bis(2-triethoxysilyl ethyl)trisulfide, bis(4-trimethoxysilyl butyl)trisulfide, bis(3-triethoxysilyl propyl)disulfide, bis(2-triethoxysilyl ethyl)disulfide, bis(4-triethoxysilyl butyl)disulfide, bis(3-trimethoxysilyl propyl)disulfide, bis(2-trimethoxysilyl ethyl)disulfide, bis(4-trimethoxysilyl butyl)disulfide, 3-trimethoxysilyl propyl-N,N-dimethyl thiocarbamoyl tetra sulfide, 2-triethoxysilylethyl-N,N-dimethyl thiocarbamoyl tetra sulfide, and 3-triethoxysilylpropyl methacrylate mono sulfide; mercapto-based agents, such as 3-mercaptopropyltrimethoxysilane, 2-mercapto ethyl triethoxysilane, and NXT and NXT-Z made by Momentive; vinyl-based agents, such as vinyl tri ethoxy silane, and vinyl trimethoxy silane; amino-based agents, such as 3-aminopropyltriethoxysilane, and 3-aminopropyl trimethoxy silane; glycidoxy-based agents, such as γ-glycidoxy propyl tri ethoxy silane, and γ-glycidoxy propyl trimethoxy silane; nitro-based agents, such as 3-nitro propyl trimethoxy silane, and 3-nitropropyl triethoxy silane; chloro-based agents, such as 3-chloropropyl trimethoxy silane, and 3-chloropropyl triethoxysilane; and the like are exemplified. Among these, a mercapto-based silane coupling agent is preferable. These may be used alone or in combination of two or more.

As the silane coupling agent, for example, products from Evonik Industries, Momentive, Shin-Etsu Silicones Ltd., Tokyo Chemical Industry Co., Ltd., AZMAX Corporation, DuPont Toray Specialty Materials, and the like can be used.

The content of the silane coupling agent with respect to 100 parts by mass of silica is, for example, preferably more than 3 parts by mass, more preferably 8 parts by mass or more, and even more preferably 10 parts by mass or more. On the other hand, the upper limit is preferably less than 25 parts by mass, more preferably less than 20 parts by mass, and even more preferably less than 15 parts by mass.

### (ii) Carbon Black

The rubber composition preferably contains carbon black in addition to silica as a reinforcing filler from the viewpoint of improving wet grip performance by improving rigidity to improve responsiveness.

The specific content of carbon black with respect to 100 parts by mass of the rubber component is preferably 2 parts by mass or more, and more preferably 4 parts by mass or more, more preferably 6 parts by mass or more. On the other hand, 15 parts by mass or less is preferable, 12 parts by mass or less is more preferable, and 10 parts by mass or less is even more preferable.

As carbon black, not particularly limited, a furnace black (furnace carbon black) such as SAF, ISAF, HAF, MAF, FEF, SRF, GPF, APF, FF, CF, SCF, or ECF; an acetylene black (acetylene carbon black); a thermal black (thermal carbon black) such as FT or MT; a channel black (channel carbon black) such as EPC, MPC, or CC are exemplified. These may be used alone or in combination of two or more.

CTAB (Cetyl Trimethyl Ammonium Bromide) specific surface area of carbon black is preferably 130 m²/g or more, more preferably 160 m²/g or more, and even more preferably 170 m²/g or more. On the other hand, 250 m²/g or less is preferable, and 200 m²/g or less is more preferable. The CTAB specific surface area is a value measured in accordance with ASTM D3765-92.

As specific carbon black, not particularly limited, N134, N110, N220, N234, N219, N339, N330, N326, N351, N550, N762, and the like are exemplified. As commercially available products, for example, products from Asahi Carbon Co. Ltd., Cabot Japan Co. Ltd., Tokai Carbon Co. Ltd., Mitsubishi Chemical Corporation, Lion Corporation, Shin-Nichika Carbon Co., Ltd., Columbia Carbon Co., Ltd, and the like can be used. These may be used alone or in combination of two or more.

(iii) Other Fillers

The rubber composition may further contain, as necessary, in addition to silica and carbon black described above, fillers commonly used in the tire industry, for example, graphite, calcium carbonate, talc, alumina, clay, aluminum hydroxide, mica, and the like. The content of these with respect to 100 parts by mass of the rubber component is, for example, more than 0.1 part by mass, and less than 200 parts by mass.

(b-2) Plasticizer Component

For the rubber composition, when considering appropriate dispersion of powder materials during kneading, using a plasticizer component as needed is preferable. The plasticizer component here refers to a component that plasticizes the rubber composition, for example, a process oil, extender oil for a rubber component, a liquid rubber, a resin component, and the like.

These plasticizer components may be derived from petroleum, may be derived from biomass, and may be derived from naphtha recycled from rubber products or non-rubber products. A low-molecular-weight hydrocarbon component obtained by pyrolysis and extraction of used tires or products containing various components may also be used as plasticizer components. Among these, biomass-derived or recycling-derived plasticizer components are preferable as sustainable plasticizer components.

The above-mentioned plasticizer component may be used alone or in combination of two or more. In this case, the content of the plasticizer component with respect to 100 parts by mass of the rubber component is preferably 20 parts by mass or more, more preferably 30 parts by mass or more, even more preferably 40 parts by mass or more. The upper limit is, for example, preferably 100 parts by mass or less, more preferably 80 parts by mass or less, even more preferably 68 parts by mass or less, even more preferably 65 parts by mass or less, and even more preferably 60 parts by mass or less.

The content of oil, contained in a rubber (oil-extended rubber), and the like, is also contained in the content of the plasticizer component.

### (i) Oil

As oil, for example, a mineral oil (commonly referred to as a process oil), a vegetable oil, or a mixture thereof are exemplified. As the mineral oil (process oil), a paraffinic process oil, an aromatic process oil, a naphthenic process oil, and the like can be used. As the vegetable oil, a castor oil, a cottonseed oil, a linseed oil, a rapeseed oil, a soybean oil, a palm oil, a coconut oil, a peanut oil, rosin, a pine oil, a pine tar, a tall oil, a corn oil, a rice bran oil, a safflower oil, a sesame oil, an olive oil, a sunflower oil, a palm kernel oil, a camellia oil, a jojoba oil, a macadamia nut oil, a tung oil, and the like are exemplified. These may be used alone or in combination of two or more. From the viewpoint of a life cycle assessment, a waste oil after used as a lubricant in a mixer for mixing rubbers, an engine for automobiles, a waste edible oil, and the like may be used as appropriate.

As a specific process oil (mineral oil), for example, products from Idemitsu Kosan Co., Ltd., Sankyo Yuka Kogyo Co., Ltd., ENEOS Corporation, Orisoi Corporation, H&R Corporation, Toyokuni Oil Mills Co., Ltd., Showa Shell Sekiyu K.K., Fuji Kosan Co., Ltd., and the like can be used.

### (ii) Liquid Rubber

The liquid rubber mentioned as the plasticizer is a polymer that is in a liquid state at room temperature (25 °C) and is a rubber component that can be extracted by an acetone extraction from a tire after vulcanized. As the liquid rubber, a farnesene-based polymer, a liquid diene-based polymer, a hydrogenated product thereof, and the like are exemplified.

The farnesene-based polymer is a polymer obtained by polymerizing farnesene, and has a structural unit based on farnesene. As farnesene, there are isomers of α-farnesene ((3E, 7E)-3,7,11-trimethyl-1,3,6,10-dodecatetraene), ß-farnesene (7,11-dimethyl-3-methylene-1,6,10-dodecatrien), and the like.

The farnesene-based polymer may be a homopolymer of farnesene (farnesene homopolymer) and may be a copolymer of farnesene with a vinyl monomer (farnesene-vinyl monomer copolymer).

As the liquid diene-based polymer, a liquid styrene butadiene copolymer (liquid SBR), a liquid butadiene polymer (liquid BR), a liquid isoprene polymer (liquid IR), a liquid styrene isoprene copolymer (liquid SIR), and the like are exemplified.

The liquid diene-based polymer has a weight average molecular weight (Mw) in terms of polystyrene measured by a gel permeation chromatography (GPC) of, for example, more than 1.0×10³, and less than 2.0×10⁵. In the present specification, Mw of the liquid diene-based polymer is a value in terms of polystyrene measured by a gel permeation chromatography (GPC).

The content of the liquid rubber (total content of the liquid farnesene-based polymer, the liquid diene-based polymer, and the like) with respect to 100 parts by mass of the rubber component is, for example, more than 1 part by mass, and less than 100 parts by mass.

As the liquid rubber, for example, products from Kuraray Co., Ltd., Cray Valley Co., Ltd., and the like can be used.

(iii) Resin Component

A resin component also functions as a tackifier component and may be solid or liquid at room temperature. As a specific resin component, resins, for example, a rosin-based resin, a styrene-based resin, a coumarone-based resin, a terpene-based resin, a C5 resin, a C9 resin, a C5C9 resin, an acrylic resin, and the like are exemplified. Among these, the C5 resin and the C9 resin are preferable. As such resins, specifically, a dicyclopentadiene resin (DCPD resin), and an AMS resin (α-methyl styrene resin) are exemplified. Two or more may be used in combination. These resin components may, as needed, also be provided with a modifying group capable of reacting with silica, and the like.

As described above, the content of the resin component with respect to 100 parts by mass of the rubber component is more than 55 parts by mass, but is more preferably more than 60 parts by mass, even more preferably 65 parts by mass or more, even more preferably more than 65 parts by mass, and even more preferably 68 parts by mass or more. The upper limit is not particularly limited, but is preferably less than 85 parts by mass, more preferably less than 80 parts by mass, even more preferably less than 75 parts by mass, and particularly preferably less than 70 parts by mass.

The rosin-based resin is a resin containing rosin acid, which is obtained by processing a pine resin, as a main component. These rosin-based resins (rosins) can be classified, based on whether modified or not, and can be divided into rosin (unmodified rosin), which is not modified, and a modified rosin (rosin derivative). As the unmodified rosin, a tall rosin (also known as a tall oil rosin), a gum rosin, a wood rosin, a disproportionated rosin, a polymerized rosin, a hydrogenated rosin, other chemically modified rosins, and the like are exemplified. The modified rosin is a modified form of the unmodified rosin, and rosin esters, unsaturated carboxylic acid-modified rosin esters, unsaturated carboxylic acid-modified rosin esters, an amide compound of rosin, an amine salt of rosin, and the like are exemplified.

The styrene-based resin is a polymer using a styrene-based monomer as a constituent monomer, and polymers obtained by polymerizing the styrene-based monomer as a main component (50% by mass or more), and the like are exemplified. Specifically, in addition to homopolymers obtained by polymerizing each of styrene-based monomers (styrene, o-methyl styrene, m-methyl styrene, p-methyl styrene, α-methyl styrene, p-methoxy styrene, p-tert-butyl styrene, p-phenyl styrene, o-chlorostyrene, m-chlorostyrene, p-chlorostyrene, and the like) alone, and copolymers obtained by copolymerizing two or more of the styrene-based monomers, copolymers of the styrene-based monomer and another monomer co-polymerizable therewith are also exemplified.

As other monomers, acrylonitriles such as acrylonitrile, and meth acrylonitrile; acryls; unsaturated carboxylic acids such as methacrylic acid; unsaturated carboxylic acid esters such as methyl acrylate, and methyl methacrylate; dienes such as chloroprene, and butadiene isoprene; olefins such as 1-butene and 1-pentene; α,ß-unsaturated carboxylic acids or acid anhydrides thereof such as maleic anhydride, and the like are exemplified.

Among the coumarone-based resins, a coumarone-indene resin is preferable. The coumarone-indene resin is a resin containing coumarone, and indene as monomer components constituting a skeleton (main chain) of the resin. Styrene, α-methyl styrene, methyl indene, vinyl toluene, and the like are exemplified as monomer components contained in the skeleton, other than coumarone, and indene.

The content of the coumarone-indene resin with respect to 100 parts by mass of the rubber component is, for example, more than 1.0 part by mass, and less than 50.0 parts by mass.

A hydroxyl value (OH value) of the coumarone-indene resin is, for example, more than 15 mg KOH/g, and less than 150 mg KOH/g. The OH value represents an amount of potassium hydroxide, expressed in milligrams, which is required to neutralize acetic acid bonding to a hydroxyl group when acetylating 1 g of the resin, and is a value measured by a potentiometric titration (JIS K 0070:1992).

A softening point of the coumarone-indene resin is, for example, higher than 30 °C, and lower than 160 °C. The softening point is a temperature at which a ball drops when the softening point specified in JIS K 6220-1: 2001 is measured using a ring and ball softening point tester.

As the terpene-based resin, a polyterpene, a terpene phenol, an aromatic-modified terpene resin, and the like are exemplified. The polyterpene is a resin obtained by polymerizing a terpene compound, and a hydrogenated product thereof. The terpene compound is a hydrocarbon represented by the formula (C₅H₈)ₙ, and an oxygen-containing derivative thereof, and is a compound having a basic skeleton of a terpene classified in a monoterpene (C₁₀H₁₆), a sesquiterpene (C₁₅H₂₄), a diterpene (C₂₀H₃₂), and the like. For example, α-pinene, ß-pinene, dipentene, limonene, myrcene, alloocimene, ocimene, α-phellandrene, α-terpinene, γ-terpinene, terpinolene, 1,8-cineole, 1,4-cineole, α-terpineol, ß-terpineol, γ-terpineol, and the like are exemplified.

As the polyterpene, in addition to terpene resins, for example, an α-pinene resin, a ß-pinene resin, a limonene resin, a dipentene resin, a ß-pinene/limonene resin, and the like, which using the above-mentioned terpene compounds as a raw material, hydrogenated terpene resins by hydrogenating the above-mentioned terpene resins are also exemplified. As the terpene phenol, a resin by copolymerizing the above-mentioned terpene compound with a phenolic compound, and a resin by hydrogenating the resins. Specifically, a resin by condensing the above-mentioned terpene compound, the phenolic compound, and formalin is exemplified. As the phenolic compound, for example, phenol, bisphenol A, cresol, xylenol, and the like are exemplified. As the aromatic-modified terpene resin, a resin obtained by modifying the terpene resin with an aromatic compound, and a resin by hydrogenating the resin. As the aromatic compound, which is not particularly limited as long as a compound having an aromatic ring, for example, a phenolic compound such as phenol, an alkylphenol, an alkoxy phenol, or an unsaturated hydrocarbon group-containing phenol; a naphthol compound such as naphthol, an alkyl naphthol, an alkoxy naphthol, or an unsaturated hydrocarbon group-containing naphthol; a styrene derivative such as styrene, an alkyl styrene, an alkoxy styrene, or an unsaturated hydrocarbon group-containing styrene; coumarone, indene, and the like are exemplified.

“C5 resin” refers to a resin obtained by polymerizing a C5 fraction. As the C5 fraction, for example, a petroleum fraction corresponding to 4 to 5 carbon atoms, such as cyclopentadiene, pentene, pentadiene, and isoprene, is exemplified. As a C5-based petroleum resin, dicyclopentadiene resin (DCPD resin) is exemplified, which is particularly preferred.

“C9 resin” refers to a resin obtained by polymerizing C9 fraction, and may be one of hydrogenating them, or one of modifying them. As the C9 fraction, for example, a petroleum fraction which corresponds to 8 to 10 carbon atoms, such as vinyl toluene, an alkyl styrene, indene, and methyl indene, is exemplified. As specific examples, for example, a coumarone-indene resin, a coumarone resin, an indene resin, and an aromatic vinyl-based resin are suitably used. As the aromatic vinyl-based resin, a homopolymer of α-methyl styrene (AMS) or styrene, or a copolymer of α-methyl styrene and styrene are preferable, and the copolymer of α-methyl styrene and styrene is more preferable, due to economic efficiency, ease of processing, and excellent heat buildup. AS the aromatic vinyl-based resin, for example, those commercially available from Kraton corporation, Eastman Chemical Company, and the like can be used.

“C5C9 resin” refers to a resin obtained by copolymerizing the above mentioned C5 fraction and the above mentioned C9 fraction and may be one by hydrogenating or one by modifying them. AS the C5 fraction, and the C9 fraction, the above-mentioned petroleum fraction can be exemplified. As the C5C9 resin, for example, those commercially available from Tosoh Corporation, LUHUA Corporation, and the like can be used.

As the acrylic resin, not particularly limited, for example, a solvent-free type acrylic resin can be used.

As the solvent-free type acrylic resin, a (meth)acrylic resin (polymer) synthesized by a high-temperature continuous polymerization (high-temperature continuous bulk polymerization) (method described in U.S. Pat. No. 4,414,370 specification, JP S59-6207 A, JP H05-58005 B, JP H01-313522 A, U.S. Pat. No. 5,010,166 specification, and Toa Gosei Kenkyusho Annual Report TREND 2000, Vol. 3, pp. 42-45, and the like), with minimal use of secondary raw materials, for example, a polymerization initiator, a chain transfer agent, an organic solvent, and the like. In the present invention, (meth)acrylic refers to both methacrylic and acrylic.

As a monomer component constituting the above mentioned acrylic resin, for example, exemplified are a (meth)acrylic acid, a (meth)acrylic acid ester (such as an alkyl ester, an aryl ester, and an aralkyl ester), a (meth)acrylamide, and a (meth)acrylic acid derivative such as a (meth)acrylamide derivative.

Furthermore, as a monomer component constituting the above-mentioned acrylic resin, an aromatic vinyl, such as styrene, α-methyl styrene, vinyl toluene, vinyl naphthalene, divinylbenzene, trivinylbenzene, or divinyl naphthalene, may be used together with a (meth)acrylic acid, or a (meth)acrylic acid derivative.

The above-mentioned acrylic resin may be a resin constituted only of a (meth)acrylic component, or a resin constituted by using constituting components also containing other than the (meth)acrylic component. The above-mentioned acrylic resin may have a hydroxyl group, a carboxyl group, a silanol group, and the like.

As the resin component, for example, products from Maruzen Petrochemical Co., Ltd., Sumitomo Bakelite Co., Ltd., Yasuhara Chemical Co., Ltd., Tosoh Corporation, Rutgers Chemicals, BASF, Arizona Chemical Company, Nitto Chemical Co., Ltd., Nippon Shokubai Co., Ltd., ENEOS Corporation, Arakawa Chemical Industries, Ltd., Taoka Chemical Co., Ltd., and the like can be used.

(b-3) Stearic Acid

It is preferable that stearic acid is contained in the rubber composition. The content of stearic acid with respect to 100 parts by mass of the rubber component is, for example, preferably more than 0.5 parts by mass, more preferably 1.5 parts by mass or more, and even more preferably 2.5 parts by mass or more. On the other hand, the upper limit is, for example, preferably less than 10.0 parts by mass, more preferably 5.0 parts by mass or less. As stearic acid, conventionally known one can be used, and, for example, products from NOF Corporation, NOF Corporation, Kao Corporation, FUJIFILM Wako Pure Chemical Industries, Ltd., Chiba Fatty Acid Co., Ltd., and the like can be used.

(b-4) Antiaging Agent

It is preferable that an antiaging agent is contained in the rubber composition. The content of the antiaging agent with respect to 100 parts by mass of the rubber component is, for example, preferably more than 0.5 parts by mass, more preferably 1 part by mass or more, and even more preferably 3 parts by mass or more. On the other hand, the upper limit is, for example, preferably less than 10 parts by mass, more preferably 8 parts by mass or less, even more preferably 5 parts by mass or less, and even more preferably 4.62 parts by mass or less.

As the antiaging agent, for example, a naphthylamine-based antiaging agent such as phenyl-α-naphthylamine; a diphenylamine-based antiaging agent such as octylated diphenylamine, or 4,4′-bis(α,α′-dimethyl benzyl)diphenylamine; a p-phenylenediamine-based antiaging agent such as N-isopropyl-N′-phenyl-p-phenylenediamine, N-(1,3-dimethylbutyl)-N′-phenyl-p-phenylenediamine, or N,N′-di-2-naphthyl-p-phenylenediamine; a quinoline-based antiaging agent such as a polymer of 2,2,4-trimethyl-1,2-dihydro quinoline; a monophenol-based antiaging agent such as 2,6-di-t-butyl-4-methyl phenol, or styrenated phenol; bis, tris, polyphenol-based antiaging agent such as tetrakis-[methylene-3-(3′, 5′-di-t-butyl-4′-hydroxyphenyl) propionate]methane, and the like are exemplified. These may be used alone or in combination of two or more.

As the antiaging agent, for example, products from Seiko Chemical Co., Ltd., Sumitomo Chemical Co., Ltd., Ouchi Shinko Chemical Industry Co., Ltd., Flexis, and the like can be used.

(b-5) Wax

It is preferable that wax is contained in the rubber composition. The content of the wax with respect to 100 parts by mass of the rubber component is, for example, preferably 0.5 parts by mass or more, more preferably 1.0 part by mass or more, even more preferably 1.5 parts by mass or more, and even more preferably 2.25 parts by mass or more. On the other hand, the upper limit is, for example, preferably 20 parts by mass or less, more preferably 15 parts by mass or less, and even more preferably 10 parts by mass or less.

As the wax, not particularly limited, a petroleum wax such as a paraffin wax or a microcrystalline wax; a natural wax such as a vegetable wax or an animal wax; a synthetic wax such as a polymer of ethylene, or propylene, or the like, and the like are exemplified. These may be used alone or in combination of two or more.

As the wax, for example, products from Ouchi Shinko Chemical Industry Co., Ltd., Nippon Seiro Co., Ltd., Seiko Chemical Co., Ltd., and the like can be used.

(b-6) Zinc Oxide

The rubber composition may contain zinc oxide. The content of zinc oxide with respect to 100 parts by mass of the rubber component is, for example, preferably more than 0.5 parts by mass, more preferably 1.0 part by mass or more, and even more preferably 2.5 parts by mass or more. On the other hand, the upper limit is, for example, preferably less than 10 parts by mass, more preferably 7 parts by mass or less, and even more preferably 5 parts by mass or less. As zinc oxide, a conventionally known one can be used, and for example, products from Mitsui Mining & Smelting Co., Ltd., Toho Zinc Co., Ltd., Haku Sui Tech Co., Ltd., Sei do Chemical Industry Co., Ltd., Sakai Chemical Industry Co., Ltd., and the like can be used.

(b-7) Crosslinking Agent and Vulcanization Accelerator

The rubber composition preferably contains a crosslinking agent such as sulfur. The content of the crosslinking agent with respect to 100 parts by mass of the rubber component is, for example, preferably more than 0.1 part by mass, more preferably 1.0 part by mass or more, and even more preferably 1.6 parts by mass or more. On the other hand, the upper limit is, for example, preferably less than 10.0 parts by mass, more preferably 5.0 parts by mass or less, and even more preferably 3.0 parts by mass or less.

As sulfur, powdered sulfur, precipitated sulfur, colloidal sulfur, insoluble sulfur, a highly dispersible sulfur, a soluble sulfur, and the like, which are commonly used in the rubber industry, are exemplified. These may be used alone or in combination of two or more.

As sulfur, for example, products from Tsurumi Chemical Industry Co., Ltd., Karuizawa Iou Co., Ltd., SHIKOKU CHEMICALS CORPORATION, Flexis Corporation, NIPPON KANRYU INDUSTRY CO., LTD, Hosoi Chemical Industry Co., Ltd, and the like can be used.

As the crosslinking agent other than sulfur, for example, a vulcanizing agent containing a sulfur atom, such as Tackirol V200 manufactured by Taoka Chemical Co., Ltd., or KA9188 (1,6-bis(N,N′-dibenzyl thio carbamoyl di thio)hexane)manufactured by LANXESS, and an organic peroxide such as di cumyl peroxide are exemplified.

The rubber composition preferably contains a vulcanization accelerator. The content of the vulcanization accelerator with respect to 100 parts by mass of the rubber component is, for example, preferably more than 0.3 parts by mass, more preferably 2.0 parts by mass or more, and even more preferably 4.0 parts by mass or more. On the other hand, the upper limit is, for example, preferably less than 10.0 parts by mass, more preferably 6.0 parts by mass or less, and even more preferably 5.2 parts by mass or less.

As the vulcanization accelerator, a thiazole-based vulcanization accelerator such as 2-mercapto benzothiazole, di-2-benzo thiazolyl disulfide, and N-cyclohexyl-2-benzothiazyl sulfenamide; a thiuram-based vulcanization accelerator such as tetramethyl thiuram disulfide (TMTD), tetra benzyl thiuram disulfide (TBzTD), and tetrakis(2-ethylhexyl) thiuram disulfide (TOT-N); a sulfenamide-based vulcanization accelerator such as N-cyclohexyl-2-benzothiazole sulfenamide, N-t-butyl-2-benzothiazolyl sulfenamide, N-oxyethylene-2-benzothiazole sulfenamide, and N,N′-diisopropyl-2-benzothiazole sulfenamide; and a guanidine-based vulcanization accelerator such as diphenyl guanidine, di-ortho tolyl guanidine, ortho tolyl biguanidine, and the like are exemplified. These may be used alone or in combination of two or more.

(b-8) Others

In the rubber composition, other than the above mentioned components, an additive commonly used in the tire industry, for example, a fatty acid metal salt, a carboxylic acid metal salt, an organic peroxide, a reversion (reversion of vulcanization) inhibitor, and the like, may be further contained, as necessary. The content of these additives with respect to 100 parts by mass of the rubber component is, for example, more than 0.1 part by mass, and less than 200 parts by mass.

### (2) Production of Rubber Composition

The rubber composition for a tread is produced by appropriately adjusting each of the various compounding materials described above and by a general method, for example, a production method including a base kneading step in which the rubber component is kneaded with a filler such as silica or carbon black, and a finish kneading step in which the kneaded product obtained in the base kneading step is kneaded with a crosslinking agent.

The kneading can be conducted using a known (internal) kneading machine, for example, a Banbury mixer, a kneader, an open roll, or the like.

The temperature for kneading in the base kneading step is, for example, higher than 50 °C, and lower than 200 °C, and a time for the kneading is, for example, more than 30 seconds and less than 30 minutes. In the base kneading step, other than the above-mentioned components, a compounding agent conventionally used in the rubber industry, for example, a softener such as oil, zinc oxide, an antiaging agent, a wax, a vulcanization accelerator, and the like, may be appropriately added and kneaded as needed.

In the finish kneading step, the kneaded product obtained in the base kneading step is kneaded with a crosslinking agent. The temperature for kneading in the finish kneading step is, for example, higher than room temperature and lower than 80 °C, and a time for the kneading is, for example, more than 1 minute and less than 15 minutes. In the finish kneading step, other than the above-mentioned components, a vulcanization accelerator, zinc oxide, and the like may be appropriately added and kneaded, as necessary.

### 2. Tire Manufacturing

A tire according to the present invention can be produced as an unvulcanized tire by molding the rubber composition obtained in the above into a tread rubber having a predetermined shape, and by molding it together with other tire components in a tire molding machine by a conventional method.

Specifically, after forming a toroidal shape by winding an inner liner as a component for ensuring the airtightness of the tire, a carcass as a component for withstanding the load, impact and inflation pressure to which the tire is subjected, a belt component as a component to fasten the carcass tightly to increase the rigidity of the tread and the like around a forming drum, fixing both ends of the carcass to both side edges and arranging bead portions as components to fix the tire to the rim, an unvulcanized tire is produced by attaching a tread to the center of the outer periphery and attaching sidewalls to the radially outer sides to form side portions.

When forming the tread portion to have a multi-layer structure with a base rubber layer, the rubber composition for forming the base rubber layer can be obtained basically by using the above-mentioned rubber components and compounding materials and by similarly kneading appropriately changing the compounding amounts thereof. Then, it can be produced as an unvulcanized tire by molding together with other tire components in a tire building machine using a normal method after extruding together with the cap rubber layer to form a tread rubber of a predetermined shape.

Then, a tire is obtained by heating and pressurizing the unvulcanized tire thus produced in a vulcanizer. The vulcanization process can be conducted by applying a known vulcanization method. The vulcanization temperature is, for example, higher than 120 °C and lower than 200 °C, and the vulcanization time is, for example, more than 5 minutes and less than 15 minutes.

As mentioned above, since the resulting tire has the appropriately controlled formulation, the relationship between the thickness of the tread portion and the fracture energy, and the like, each effect is exhibited synergistically so that wet grip performance can be further improved.

The tire according to the present invention is not particularly limited to a particular category, and can be used as a passenger car tire, a large passenger car tire, a large SUV tire, a truck/bus tire, a motorcycle tire, a racing tire, a studdles tire (winter tire), an all-season tire, a run-flat tire, an aircraft tire, a mining tire, a non-pneumatic tire, and the like, but is preferably used as a passenger car tire.

### EXAMPLE

Embodiments (examples) that are considered preferable for conducting the present invention, are described below, but the scope of the present invention is not limited to the examples.

The tires, comprising a tread molded from various compounding materials shown below, and other rubber components, are examined, and the results, calculated based on an evaluation method for wear resistance, chipping resistance, and the overall performance of both described below, are shown at the bottom of Tables 2 and 3.

### 1. Rubber Composition for Forming the Cap Rubber Layer

A rubber composition for forming the cap rubber layer of the tread portion is prepared using the various compounding materials shown below.

### (1) Compounding Materials

### (a) Rubber Component

(a-1) NR: TSR-20
(a-3) SBR-1: Modified S-SBR (styrene content: 20% by mass, vinyl content: 20% by mass, Tg: −60 °C, Mw: 650,000) produced according to the production example described below
(a-4) SBR-2: SSBR HPR850 (styrene content: 26% by mass, vinyl content: 59% by mass, Tg: −25 °C, Mw: 200,000, non-oil extended product) manufactured by ENEOS Materials Corporation
(a-4) BR: Ubepol BR150B (Hi-sis BR) manufactured by Ube Industries, Ltd. (cis content 97% by mass, trans content 2% by mass, vinyl content 1% by mass)

### Production Example 1: Production of SBR-1

SBR-1 is prepared according to the following procedure. First, cyclohexane, tetrahydrofuran, styrene, and 1,3-butadiene are charged into a nitrogen-purged autoclave reactor. After adjusting the temperature of the content of the reactor, n-butyllithium is added to initiate polymerization. The polymerization is then conducted under adiabatic conditions. When the conversion rate of the polymerization reaches 99%, 1,3-butadiene is added, and polymerization is continued for an additional 5 minutes. 3-dimethylamino propyl triethoxysilane is then added as a modifying agent to be reacted. After the polymerization reaction is completed, 2,6-di-tert-butyl-p-cresol is added, and solvent is removed by steam stripping. The obtained is then dried using a heated roll to obtain SBR-1.

(b) Compounding Materials Other than Rubber Components
(b-1) Silica: Ultrasil 9100Gr manufactured by Evonik Industries (N2SA: 235 m²/g, average particle size: 15 nm)
(b-2) Silane coupling agent-1: Si266 manufactured by Evonik Industries (Bis (3-triethoxysilylpropyl)disulfide)
(b-3) Silane coupling agent-2: NXT manufactured by Momentive (3-octanoylthiopropyltriethoxysilane)
(b-4) Carbon black: DIABLACK N220 manufactured by Mitsubishi Chemical Corporation
   (N2SA: 115 m²/g)
(b-5) Resin component: PR383 manufactured by ExxonMobil Corporation (Hydrogenated DCPD/C9 resin, softening point: 100 °C)
(b-6) Oil: H&R Vivatec 500
   (Aromatic process oil: TDAE oil)
(b-7) Zinc oxide: Zinc oxide 2 type manufactured by Mitsui Mining & Smelting Co., Ltd.
(b-8) Anti-aging agent-1: Antigen 6C manufactured by Sumitomo Chemical Co., Ltd.
   (N-(1,3-dimethylbutyl)-N′-phenyl-p-phenylenediamine)
(b-9) Anti-aging agent-2: Antigen RD manufactured by Kawaguchi Chemical Industry Co., Ltd.
   (2,2,4-trimethyl-1,2-dihydroquinoline polymer)
(b-10) Stearic acid: Stearic acid beads “Tsubaki” manufactured by NOF Corporation
(b-11) Wax: OZOACE 0355 manufactured by Nippon Seiro Co., Ltd.
(b-12) Sulfur: Powdered sulfur (containing 5% oil) manufactured by Tsurumi Chemical Industry Co., Ltd.
(b-13) Vulcanization accelerator-1: Nocceler CZ manufactured by Ouchi Shinko Chemical Industry Co., Ltd.
   (N-cyclohexyl-2-benzothiazyl sulfenamide (CBS))
(b-14) Vulcanization accelerator-2: Nocceler DPG manufactured by Ouchi Shinko Chemical Industry Co., Ltd.
   (Diphenylguanidine (DPG))

### (2) Production of Rubber Composition

Based on the formulations shown in Tables 2 and 3, materials, other than sulfur and a vulcanization accelerator, are kneaded for 5 minutes at 150 °C using a 1.7 L Banbury mixer manufactured by Kobe Steel, Ltd. to obtain kneaded mixtures.

Next, the kneaded mixture is added with sulfur and a vulcanization accelerator and is kneaded for 5 minutes at 80 °C using an open roll to obtain rubber compositions for forming the cap rubber layer.

### 2. Preparation of the Rubber Composition for Forming the Base Rubber Layer

In parallel, a rubber composition for forming base rubber layers is obtained based on the formulation shown in Table 1 in the same manner as the rubber composition for forming the cap rubber layer.

TABLE 1

| | Compounding |
|---|---|
| | amount (parts |
| Compounding material | by mass) |
| NR (TSR20) | 70 |
| BR (UBEPOL-BR150B manufactured by Ube | 30 |
| Industries, Ltd.) | |
| Carbon black (Showblack N330 T manufactured | 35 |
| by Cabot Japan) | |
| Stearic acid (stearic acid “Tsubaki” | 2 |
| manufactured by NOF Corporation) | |
| Zinc oxide (Zinc oxide No. 1 manufactured by | 4 |
| Mitsui Mining & Smelting Co., Ltd.) | |
| Wax (SUNNOC Wax manufactured by Ouchi | 2 |
| Shinko Chemical Industry Co., Ltd.) | |
| Anti-aging agent-1 (Crack 6C manufactured by | 3 |
| Ouchi Shinko Chemical Industry Co., Ltd.) | |
| Anti-aging agent-2 (ANTAGE RD manufactured by | 1 |
| Kawaguchi Chemical Industry Co., Ltd.) | |
| Sulfur (powdered sulfur manufactured by | 1.7 |
| Tsurumi Chemical Industry Co., Ltd.) | |
| Vulcanization accelerator (Nocceler-CZ-G | 1.2 |
| manufactured by Ouchi Shinko Chemical | |
| Industry Co., Ltd.) | |

### 3. Manufacturing of Pneumatic Tires

Each rubber composition is used to mold treads having a cap rubber layer and a base rubber layer in a predetermined shape.

Thereafter, after molded together with other tire components to form unvulcanized tires, press-vulcanization is carried out for 10 minutes under a condition of 170 °C to produce each test tire (tire size: 255/45R22, aspect ratio: 45%, negative ratio: 33%, cap thickness: 3 mm, tread thickness: 12.5 mm, cap ratio: 24%) of Examples 1 to 6 and Comparative Examples 1 to 6 shown in Tables 2 and 3.

### 4. Physical Properties of Vulcanized Rubber

Next, a viscoelasticity measurement sample measuring 20 mm in length×4 mm in width×1 mm in thickness is taken from inside the cap rubber layer of the tread portion of each test tire, with the long side aligned in the tire circumferential direction. Using an “EPLEXOR (registered trademark)” series manufactured by GABO, the loss tangent tan δ is measured at each measurement temperature (0 °C, −20 °C, −30 °C, −40 °C) under the conditions of a frequency of 10 Hz, an initial strain of 5%, a dynamic strain rate of 1%, and a deformation mode of tension. In addition, the complex modulus of elasticity (0 °C E*) is measured under the conditions of a temperature of 0 °C, a frequency of 10 Hz, an initial strain of 5%, a dynamic strain rate of 1%, and a deformation mode of elongation. The thick direction of the sample is made to be the radial direction of the tire. When the same formulation is used across multiple examples, an average value of values measured from each test tire is used.

The glass transition temperature of each sample is measured in the same manner as the glass transition temperature (Tg) of SBR described above. Specifically, it is determined from a temperature distribution curve of loss tangent (tan δ) measured using an “EPLEXOR (registered trademark)” series viscoelasticity measuring device manufactured by GABO Corporation. Specifically, the temperature distribution curve of tan δ is measured under conditions of a frequency of 10 Hz, an initial strain of 10%, an amplitude of ±0.5%, and a heating rate of 2 °C/min, and the temperature corresponding to the largest tan δ value in the range of −60 °C to 40 °C on the measured temperature distribution curve is taken as the glass transition temperature.

If there are two or more points with the largest tan δ value within the range of −100 °C or higher and 40 °C or lower, the point with the lowest temperature is taken as the glass transition temperature. For example, if a peak of 6 is within the range of −100 °C or higher and 40 °C or lower, the peak temperature is the glass transition temperature according to the above definition. Furthermore, if the peak of tan δ is in a region below −100 °C and a temperature distribution curve is obtained in which tan δ gradually decreases with increasing temperature within the range of −100 °C or higher and 40 °C or lower, the glass transition temperature is −100 °C according to the above definition.

Then, B1, B1×cap ratio, SBR content×aspect ratio, silica content/negative rate, and resin component content/negative rate are calculated.

### 5. Performance Evaluation Test

### (1) Evaluation of Wear Resistance

Each test tire is mounted on all wheels of a test vehicle, and the vehicle is driven on a test course with a dry asphalt surface. After driving a specified distance, the groove depth of the tire tread is measured, and the running distance when the tire groove depth decreases by 1 mm is calculated.

Next, the result of Comparative Example 1 is set to 100, and the abrasion resistance is evaluated by indexing it according to the following formula. A larger value indicates better abrasion resistance.

Abrasion resistance performance=[(Results of Test tire)/(Result of Comparative Example 1)]×100

### (2) Chipping Resistance

Each test tire is mounted on a standardized rim, and inflated with air to a standardized internal pressure (250 kPa), then mounted on all wheels of a test vehicle (displacement of 2000 cc, front-wheel drive), and driven the test vehicle on rough terrain at 50 km/h for 4 hours. After that, length in the circumferential direction of all cracks that develop on the tire surface is measured, and the maximum value is determined.

Next, chipping resistance is evaluated by making the result of Comparative Example 1 as 100, and by indexing based on the following formula. A larger value indicates better chipping resistance.

Chipping resistance=[(Result of Comparative Example 1)/(Results of test tire)]×100

TABLE 2

| | | | | | | Comparative |
|---|---|---|---|---|---|---|
| Example | | | | | | Example |
| 1 | 2 | 3 | 4 | 5 | 6 | 1 |

Formulation of cap rubber composition [parts by mass]

| | | | | | | | |
|---|---|---|---|---|---|---|---|
| NR | 16 | 10 | 30 | 30 | 30 | 30 | 16 |
| SBR-1 | 74 | 74 | 40 | 40 | 40 | 40 | 74 |
| SBR-2 | — | — | 20 | 20 | 20 | 20 | — |
| BR | 10 | 16 | 10 | 10 | 10 | 10 | 10 |
| Carbon Black | 10 | 10 | 10 | 10 | 10 | 10 | 10 |
| Silica | 100 | 100 | 100 | 100 | 135 | 100 | 95 |
| Silane coupling | 10 | 10 | 10 | — | 13.5 | 10 | 9.5 |
| agent-1 | | | | | | | |
| Silane coupling | — | — | — | 10 | — | — | — |
| agent-2 | | | | | | | |
| Oil | — | — | — | — | — | — | — |
| Resin component | 68 | 68 | 68 | 68 | 68 | 65 | 56 |
| Wax | 2.25 | 2.25 | 2.25 | 2.25 | 2.25 | 2.25 | 2.25 |
| Anti-aging agent-1 | 3.5 | 3.5 | 3.5 | 3.5 | 3.5 | 3.5 | 3.5 |
| Anti-aging agent-2 | 1.12 | 1.12 | 1.12 | 1.12 | 1.12 | 1.12 | 1.12 |
| Stearic acid | 2.5 | 2.5 | 2.5 | 2.5 | 2.5 | 2.5 | 2.5 |
| Zinc oxide | 2.5 | 2.5 | 2.5 | 2.5 | 2.5 | 2.5 | 2.5 |
| Sulfur | 1.6 | 1.6 | 1.6 | 1.6 | 1.6 | 1.6 | 1.6 |
| Vulcanization | 2.4 | 2.4 | 2.4 | 2.4 | 2.4 | 2.4 | 2.4 |
| accelerator-1 | | | | | | | |
| Vulcanization | 2.8 | 2.8 | 2.8 | 2.8 | 2.8 | 2.8 | 2.8 |
| accelerator-2 | | | | | | | |

Physical Properties of Rubber Composition

| | | | | | | | |
|---|---|---|---|---|---|---|---|
| Styrene content of | 20.0 | 20.0 | 22.0 | 22.0 | 22.0 | 22.0 | 20.0 |
| SBR (% by mass) | | | | | | | |
| Tg (°C) | −19.6 | −21.8 | −15.6 | −15.9 | −15.7 | −16.5 | −21.3 |
| 0 °C E* (MPa) | 10.87 | 10.77 | 15.80 | 10.43 | 17.00 | 16.10 | 10.07 |
| 0 °C tanδ | 0.65 | 0.62 | 0.82 | 0.76 | 0.75 | 0.79 | 0.54 |
| −40 °C tanδ | 0.16 | 0.17 | 0.18 | 0.17 | 0.30 | 0.20 | 0.15 |
| −30 °C tanδ | 0.41 | 0.39 | 0.39 | 0.39 | 0.46 | 0.40 | 0.33 |
| −20 °C tanδ | 0.63 | 0.58 | 0.61 | 0.71 | 0.59 | 0.62 | 0.58 |
| B1 | 0.071 | 0.065 | 0.061 | 0.093 | 0.060 | 0.060 | 0.057 |

Calculation parameters

| | | | | | | | |
|---|---|---|---|---|---|---|---|
| B1 × cap ratio | 1.70 | 1.56 | 1.46 | 2.16 | 1.43 | 1.44 | 1.37 |
| SBR content × | 3330 | 3330 | 2700 | 2700 | 2700 | 2700 | 3330 |
| flatness | | | | | | | |
| Silica content/ | 3.03 | 3.03 | 3.03 | 3.03 | 4.09 | 3.03 | 2.88 |
| negative rate | | | | | | | |
| Resin component | 2.06 | 2.06 | 2.06 | 2.06 | 2.06 | 1.97 | 1.70 |
| content/negative | | | | | | | |
| rate | | | | | | | |

Performance evaluation

| | | | | | | | |
|---|---|---|---|---|---|---|---|
| Wear resistance | 103 | 101 | 118 | 114 | 110 | 118 | 100 |
| Chipping resistance | 103 | 101 | 99 | 110 | 92 | 98 | 100 |
| Overall performance | 206 | 202 | 217 | 224 | 202 | 216 | 200 |

TABLE 3

| Comparative Example | | | |
|---|---|---|---|
| 2 | 3 | 4 | 5 |

Formulation of cap rubber composition [parts by mass]

| | | | | |
|---|---|---|---|---|
| NR | — | — | 16 | 16 |
| SBR-1 | 90 | 90 | 74 | 50 |
| SBR-2 | — | — | — | 24 |
| BR | 10 | 10 | 10 | 10 |
| Carbon Black | 10 | 10 | 10 | 10 |
| Silica | 90 | 90 | 105 | 85 |
| Silane coupling agent-1 | 9 | 9 | 10.5 | 8.5 |
| Silane coupling agent-2 | — | — | — | — |
| Oil | — | — | — | 20 |
| Resin component | 56 | 50 | 65 | 20 |
| Wax | 2.25 | 2.25 | 2.25 | 2.25 |
| Anti-aging agent-1 | 3.5 | 3.5 | 3.5 | 3.5 |
| Anti-aging agent-2 | 1.12 | 1.12 | 1.12 | 1.12 |
| Stearic acid | 2.5 | 2.5 | 2.5 | 2.5 |
| Zinc oxide | 2.5 | 2.5 | 2.5 | 2.5 |
| Sulfur | 1.6 | 1.6 | 1.6 | 1.6 |
| Vulcanization | 2.4 | 2.4 | 2.4 | 2.4 |
| accelerator-1 | | | | |
| Vulcanization | 2.8 | 2.8 | 2.8 | 2.8 |
| accelerator-2 | | | | |

Physical properties of rubber composition

| | | | | |
|---|---|---|---|---|
| Styrene content of SBR | 20.0 | 20.0 | 20.0 | 21.9 |
| (% by mass) | | | | |
| Tg (°C) | −19.7 | −21.4 | −19.8 | −30.2 |
| 0 °CE* (MPa) | 9.88 | 9.50 | 12.17 | 22.33 |
| 0 °C tanδ | 0.55 | 0.54 | 0.59 | 0.48 |
| −40 °C tanδ | 0.15 | 0.15 | 0.15 | 0.13 |
| −30 °C tanδ | 0.41 | 0.38 | 0.31 | 0.29 |
| −20 °C tanδ | 0.64 | 0.62 | 0.55 | 0.55 |
| B1 | 0.067 | 0.065 | 0.049 | 0.021 |

Calculation parameters

| | | | | |
|---|---|---|---|---|
| B1 × cap ratio | 1.61 | 1.56 | 1.18 | 0.50 |
| SBR content × flatness | 4050 | 4050 | 3330 | 3330 |
| Silica content/negative | 2.73 | 2.73 | 3.18 | 2.58 |
| rate | | | | |
| Resin component | 1.70 | 1.52 | 1.97 | 0.61 |
| content/negative rate | | | | |

Performance evaluation

| | | | | |
|---|---|---|---|---|
| Wear resistance | 99 | 95 | 101 | 104 |
| Chipping resistance | 96 | 96 | 99 | 93 |
| Overall performance | 195 | 191 | 200 | 197 |

Although the present invention has been described above based on the embodiments, the present invention is not limited to the above-described embodiments. Various modifications can be made to the above-described embodiments within the same and equivalent scope to the present invention.

The present invention (1) is
a tire comprising a tread portion, wherein
the tread portion includes a cap rubber layer formed to a thickness (mm) having a ratio C (%) to a total thickness (mm) of the tread portion (mm),
the cap rubber layer is formed by using a rubber composition which contains styrene butadiene rubber (SBR) having a styrene content of less than 25% by mass in a rubber component, and further contains more than 90 parts by mass of silica, and more than 55 parts by mass of a resin component with respect to 100 parts by mass of the rubber component,
a complex modulus of elasticity 0 °C E* (MPa) of the cap rubber layer (measured under the conditions of a temperature of 0 °C, a frequency of 10 Hz, an initial strain of 5%, a dynamic strain rate of 1%, and a deformation mode of elongation), and loss tangents (0 °C tan δ, −20 °C tan δ, −30 °C tan δ, and −40 °C tan δ) of the cap rubber layer (measured under the conditions of a frequency of 10 Hz, an initial strain of 5%, a dynamic strain rate of 1%, a deformation mode of tension, and temperatures of 0 °C, −20 °C, −30 °C, and −40 °C respectively) satisfy the following formula (1), and
the following formula (2) is satisfied by B1 shown in the following formula (1), and the ratio C (%).

B1[={(−40 °C tan δ)+(−30 °C tan δ)+(−20 °C tan δ)}×0 °C tan δ/0 °CE*]≥0.060 (1)

B1×C>1.0 (2)

The present invention (2) is the tire according to claim 1, wherein the value of B1 is more than 0.065.

The present invention (3) is the tire according to claim 2, wherein the value of B1 is more than 0.070.

The present invention (4) is the tire which is characterized in that styrene butadiene rubber (SBR) in the rubber component has the styrene content of 20% by mass or less, and is an optional combination with any of the present inventions (1) to (3).

The present invention (5) is the tire according to the present invention (4), wherein styrene butadiene rubber (SBR) in the rubber component has the styrene content of 15% by mass or less.

The present invention (6) is the tire which is characterized in that a product of a content (parts by mass) of styrene butadiene rubber (SBR) in 100 parts by mass of the rubber component and an aspect ratio (%) of the tire is more than 2,000, and is an optional combination with any one of the present inventions (1) to (5).

The present invention (7) is the tire which is characterized in that a ratio of a content (parts by mass) of the silica with respect to 100 parts by mass of the rubber component to a negative rate (%) on the surface of the tread portion is more than 3, and is an optional combination with any one of the present inventions (1) to (6).

The present invention (8) is the tire which is characterized in that the silica has an average particle size of 16 nm or less, and is an optional combination with any one of the present inventions (1) to (7).

The present invention (9) is the tire which is characterized in that the resin component is dicyclopentadiene resin or α-methylstyrene resin, and is an optional combination with any one of the present inventions (1) to (8).

The present invention (10) is the tire which is characterized in that the product of the value of B1 and the ratio (%) of the thickness of the cap rubber layer to the thickness of the tread portion is more than 1.5, and is an optional combination with any one of the present inventions (1) to (9).

The present invention (11) is the tire which is characterized in that the rubber composition contains a mercapto-based silane coupling agent, and is any combination with any one of the present inventions (1) to (10).

The present invention (12) is the tire which is characterized in that a content of styrene-butadiene rubber (SBR) in 100 parts by mass of the rubber component is more than 50 parts by mass, and is any combination with any one of the present inventions (1) to (11).

The present invention (13) is the tire which is characterized in that the rubber composition contains an isoprene-based rubber as the rubber component, and is any combination with any one of the present inventions (1) to (12).

The present invention (14) is the tire which is characterized in that a content of the silica in the rubber composition is less than 190 parts by mass with respect to 100 parts by mass of the rubber component, and is any combination with any one of the present inventions (1) to (13).

1. A tire comprising a tread portion, wherein
the tread portion includes a cap rubber layer formed to a thickness (mm) having a ratio C (%) to a total thickness (mm) of the tread portion (mm),
the cap rubber layer is formed by using a rubber composition which contains styrene butadiene rubber (SBR) having a styrene content of less than 25% by mass in a rubber component, and further contains more than 90 parts by mass of silica, and more than 55 parts by mass of a resin component with respect to 100 parts by mass of the rubber component,
a complex modulus of elasticity 0 °C E* (MPa) of the cap rubber layer (measured under the conditions of a temperature of 0 °C, a frequency of 10 Hz, an initial strain of 5%, a dynamic strain rate of 1%, and a deformation mode of elongation), and loss tangents (0 °C tan δ, −20 °C tan δ, −30 °C tan δ, and −40 °C tan δ) of the cap rubber layer (measured under the conditions of a frequency of 10 Hz, an initial strain of 5%, a dynamic strain rate of 1%, a deformation mode of tension, and temperatures of 0 °C, −20 °C, −30 °C, and −40 °C respectively) satisfy the following formula (1), and
the following formula (2) is satisfied by B1 shown in the following formula (1), and the ratio C (%).
Bl[={(−40 °C tan δ)+(−30 °C tan δ)+(−20 °C tan δ)}×0 °C tan δ/0 °CE*]≥0.060 (1)
B1×C>1.0 (2)

2. The tire according to claim 1, wherein the value of B1 is more than 0.065.

3. The tire according to claim 2, wherein the value of B1 is more than 0.070.

4. The tire according to claim 1, wherein styrene butadiene rubber (SBR) in the rubber component has the styrene content of 20% by mass or less.

5. The tire according to claim 4, wherein styrene butadiene rubber (SBR) in the rubber component has the styrene content of 15% by mass or less.

6. The tire according to claim 1, wherein a product of a content (parts by mass) of styrene butadiene rubber (SBR) in 100 parts by mass of the rubber component and an aspect ratio (%) of the tire is more than 2,000.

7. The tire according to claim 1, wherein a ratio of a content (parts by mass) of the silica with respect to 100 parts by mass of the rubber component to a negative rate (%) on the surface of the tread portion is more than 3.

8. The tire according to claim 1, wherein the silica has an average particle size of 16 nm or less.

9. The tire according to claim 1, wherein the resin component is dicyclopentadiene resin or α-methylstyrene resin.

10. The tire according to claim 1, wherein the product of the value of B1 and the ratio (%) of the thickness of the cap rubber layer to the thickness of the tread portion is more than 1.5.

11. The tire according to claim 1, wherein the rubber composition contains a mercapto-based silane coupling agent.

12. The tire according to claim 1, wherein a content of styrene-butadiene rubber (SBR) in 100 parts by mass of the rubber component is more than 50 parts by mass.

13. The tire according to claim 1, wherein the rubber composition contains an isoprene-based rubber as the rubber component.

14. The tire according to claim 1, wherein a content of the silica in the rubber composition is less than 190 parts by mass with respect to 100 parts by mass of the rubber component.
